(19) United States
(12) Patent Application Publication
(10) Pub. No.: US 2025/0073990 A1
(43) Pub. Date: Mar. 6, 2025

(54) SCANNING ENERGY SYSTEMS FOR ADDITIVE MANUFACTURING AND ASSOCIATED METHODS

(71) Applicant: Align Technology, Inc., San Jose, CA (US)

(72) Inventors: Michael Christopher Cole, San Jose, CA (US); Stuart Macrae Montgomery, San Jose, CA (US); Xirui Peng, Apex, NC (US); Yuxiang Wang, Newark, CA (US)

(21) Appl. No.: 18/821,709

(22) Filed: Aug. 30, 2024

Related U.S. Application Data
(60) Provisional application No. 63/580,091, filed on Sep. 1, 2023.
(60) Provisional application No. 63/594,678, filed on Oct. 31, 2023.

(51) Int. Cl. B29C 64/135; B29C 64/268; B29C 64/277; B29K 105/00; B33Y 10/00; B33Y 30/00; B33Y 80/00

(52) U.S. Cl. CPC B29C 64/135; B29C 64/268; B29C 64/277; B33Y 10/00; B33Y 30/00; B33Y 80/00; B29K 2105/0002

(57) ABSTRACT

Systems and methods for additive manufacturing are provided. In some embodiments, a method for additive manufacturing includes forming a portion of an additively manufactured object within a reservoir of curable material by scanning a plurality of energy beams of a plurality of energy sources through a plurality of respective scanning regions in the curable material. The scanning regions can overlap at one or more object locations, such that a combined energy dosage delivered to the one or more object locations by two or more of the energy beams is greater than or equal to a threshold dosage for solidifying the curable material. The method can further include advancing the reservoir of curable material relative to the energy sources. The forming and advancing processes can be repeated to fabricate the additively manufactured object.

### CROSS-REFERENCE TO RELATED APPLICATION(S)

The present application claims the benefit of priority to U.S. Provisional Application No. 63/580,091, filed Sep. 1, 2023, and U.S. Provisional Application No. 63/594,678, filed Oct. 31, 2023, the disclosures of each of which are incorporated by reference herein in their entirety.

### TECHNICAL FIELD

The present technology generally relates to manufacturing, and in particular, to scanning energy systems for additive manufacturing and associated methods.

### BACKGROUND

Additive manufacturing (also known as “3D printing”) includes a variety of technologies which fabricate 3D objects through an additive process. Conventional additive manufacturing processes typically involve building up a 3D object from multiple layers of a material. However, conventional layer-by-layer additive manufacturing processes may be impractical for large-scale manufacturing due to their slow printing speeds (e.g., it may take hours to print a single object), since the printing speed generally depends on the number of layers in the object, the thickness of each layer, and the time to print each layer. Volumetric additive manufacturing processes can be used to produce an object from a volume of resin in a single print step without requiring layer-by-layer build up, and thus can provide significantly faster printing speeds (e.g., an entire object can be printed in seconds). However, volumetric additive manufacturing processes typically require specialized hardware and materials, which may increase costs and limit the range of usable materials.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a partially schematic front cross-sectional view of an additive manufacturing system configured in accordance with embodiments of the present technology.

FIG. 1B is a partially schematic side cross-sectional view of the system of FIG. 1A.

FIG. 2 is a partially schematic diagram showing selective solidification of a curable material using multiple energy beams, in accordance with embodiments of the present technology.

FIGS. 3A and 3B are partially schematic diagrams showing selective solidification of a curable material using multiple energy beams, in accordance with embodiments of the present technology.

FIG. 4A is a partially schematic front cross-sectional view of the system of FIGS. 1A and 1B during a stage of operation, in accordance with embodiments of the present technology.

FIG. 4B is a partially schematic side cross-sectional view of the system of FIG. 4A.

FIG. 4C is a partially schematic front cross-sectional view of the system of FIGS. 1A and 1B during a subsequent stage of operation, in accordance with embodiments of the present technology.

FIG. 4D is a partially schematic side cross-sectional view of the system of FIG. 4C.

FIG. 5A is a partially schematic front cross-sectional view of an additive manufacturing system including three energy sources, in accordance with embodiments of the present technology.

FIG. 5B is a partially schematic side view of an additive manufacturing system with angled energy sources, in accordance with embodiments of the present technology.

FIG. 5C is a partially schematic side view of an additive manufacturing system with offset energy sources in accordance with embodiments of the present technology.

FIG. 6A is a partially schematic diagram of an energy beam having a constant diameter, in accordance with embodiments of the present technology.

FIG. 6B is a partially schematic diagram of an energy beam having a converging diameter, in accordance with embodiments of the present technology.

FIG. 7 is a partially schematic front cross-sectional view of an additive manufacturing system including a reservoir with angled walls, in accordance with embodiments of the present technology.

FIG. 8A is a partially schematic front cross-sectional view of an additive manufacturing system including a reflective element, in accordance with embodiments of the present technology.

FIG. 8B is a partially schematic front cross-sectional view of an additive manufacturing system including a reservoir with a reflective element, in accordance with embodiments of the present technology.

FIG. 8C is a partially schematic front cross-sectional view of an additive manufacturing system including a reservoir that acts as a reflective element, in accordance with embodiments of the present technology.

FIG. 8D is a partially schematic front cross-sectional view of an additive manufacturing system including a reservoir with an array of reflective elements, in accordance with embodiments of the present technology.

FIGS. 9A-9C illustrate various curing patterns that can be used to form an additively manufactured object, in accordance with embodiments of the present technology.

FIG. 10A is a flow diagram illustrating a method for determining scanning parameters for fabricating an additively manufactured object, in accordance with embodiments of the present technology.

FIG. 10B illustrates a method for determining scanning parameters using a prediction model, in accordance with embodiments of the present technology.

FIG. 11 is a schematic block diagram illustrating a workflow for determining energy intensities for fabricating an additively manufactured object, in accordance with embodiments of the present technology.

FIG. 12 is a flow diagram illustrating a method for fabricating an additively manufactured object, in accordance with embodiments of the present technology.

FIG. 13 is a flow diagram illustrating a method for fabricating and processing an additively manufactured object, in accordance with embodiments of the present technology.

FIG. 14A illustrates a representative example of a tooth repositioning appliance configured in accordance with embodiments of the present technology.

FIG. 14B illustrates a tooth repositioning system including a plurality of appliances, in accordance with embodiments of the present technology.

FIG. 14C illustrates a method of orthodontic treatment using a plurality of appliances, in accordance with embodiments of the present technology.

FIG. 15 illustrates a method for designing an orthodontic appliance, in accordance with embodiments of the present technology.

FIG. 16 illustrates a method for digitally planning an orthodontic treatment and/or design or fabrication of an appliance, in accordance with embodiments of the present technology.

FIG. 17A is a heatmap image illustrating a globally optimized light dosage using three collimated lasers and two reflective walls.

FIG. 17B is a heatmap image of the target shape for the optimization of FIG. 17A.

FIG. 18A is a heatmap image illustrating a globally optimized light dosage using five collimated lasers and two reflective walls.

FIG. 18B is a heatmap image of the target shape for the optimization of FIG. 18A.

FIG. 19A is a heatmap image illustrating a globally optimized light dosage using ten collimated lasers and two reflective walls.

FIG. 19B is a heatmap image of the target shape for the optimization of FIG. 19A.

FIG. 20A is a heatmap image illustrating a locally optimized light dosage using ten collimated lasers and two reflective walls.

FIG. 20B is a heatmap image of the target shape for the optimization of FIG. 20A.

FIG. 21A is a heatmap image illustrating a locally optimized light dosage using ten converging lasers and two reflective walls.

FIG. 21B is a heatmap image of the target shape for the optimization of FIG. 21A.

FIG. 22A is a heatmap image illustrating a target object shape.

FIG. 22B is a heatmap illustrating a predicted global light dosage using five lasers and layer-by-layer scanning.

FIG. 22C is a heatmap illustrating a predicted global light dosage using five lasers and volumetric scanning.

FIG. 22D is a heatmap illustrating a predicted global light dosage using one laser and layer-by-layer scanning.

### DETAILED DESCRIPTION

The present technology relates to additive manufacturing of objects such as dental appliances. In some embodiments, for example, a method for fabricating an additively manufactured object includes forming a portion of an additively manufactured object within a reservoir of curable material using a first energy beam of a first energy source and a second energy beam of a second energy source. The first energy beam can be scanned through a first scanning region within the reservoir of the curable material, and the second energy source can be scanned through a second scanning region within the reservoir of the curable material. The second scanning region can overlap the first scanning region at one or more object locations, such that a combined energy dosage delivered to the object locations is greater than or equal to a threshold dosage for solidifying the curable material, thus forming the portion of the additively manufactured object. Conversely, the combined energy dosage delivered to other locations in the curable material may remain below the threshold dosage such that the curable material is not solidified at those locations. The method can further include advancing the reservoir of curable material relative to the first and second energy sources. The forming and advancing processes can be repeated to fabricate the entirety of the additively manufactured object.

In some embodiments, the present technology provides software algorithms for determining scanning parameters for fabricating an additively manufactured object using a plurality of energy sources as described herein. For example, a software algorithm can be configured to perform the following operations: receiving a 3D digital representation of an object to be fabricated; generating a plurality of 2D cross-sections from the 3D digital representation; determining scanning parameters for a plurality of energy sources to form the plurality of 2D cross-sections of the object from a curable material; and generating instructions for fabricating the object from the curable material using the plurality of energy sources with the scanning parameters.

The present technology can provide many advantages compared to conventional additive manufacturing techniques. For instance, although certain embodiments of the present technology herein may involve forming an object via a layer-by-layer process, the thickness of an individual layer can be significantly greater than the layer thicknesses in conventional additive manufacturing processes such as stereolithography (SLA), thus providing significantly faster printing speeds. The additive manufacturing processes disclosed herein also allow an object to be fabricated without requiring temporary support structures to attach the object to the build platform, thus reducing the amount of post-processing needed to prepare the object for use. Moreover, the systems and methods described herein do not require highly specialized hardware and materials, unlike conventional volumetric printing techniques (e.g., computed axial lithography (CAL) volumetric printing requires a rotating resin container with optically transparent walls, xolography requires a photoinitiator that is activated by two different wavelengths). Additionally, the systems and methods described herein can continuously solidify 2D object cross-sections as the curable material is continuously advanced through the scanning regions of the energy sources, thereby allowing for compatibility with conveyor-based mechanisms for non-stop high-throughput printing of the objects.

The software algorithms for calculating the scanning parameters for the additive manufacturing processes disclosed herein may also be computationally simpler than those for conventional volumetric printing techniques, while also providing precise delivery of the correct light dosage to each voxel in the printing volume to ensure accuracy of the printed object. For instance, the software algorithms describe herein can provide an optimization procedure to calculate the ideal laser intensity, laser position, reflective surface orientation, etc., that achieves a desired global light dosage distribution, while considering laser penetration, reflection, diffraction, light decay, thermal build-up, and/or other phenomena that may affect the delivered dosage and/or extent of curing of the resin. Accordingly, the present technology can be used to produce large numbers of additively manufactured objects in a rapid, accurate, and cost-efficient manner.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

I. Additive Manufacturing with Scanning Energy Systems

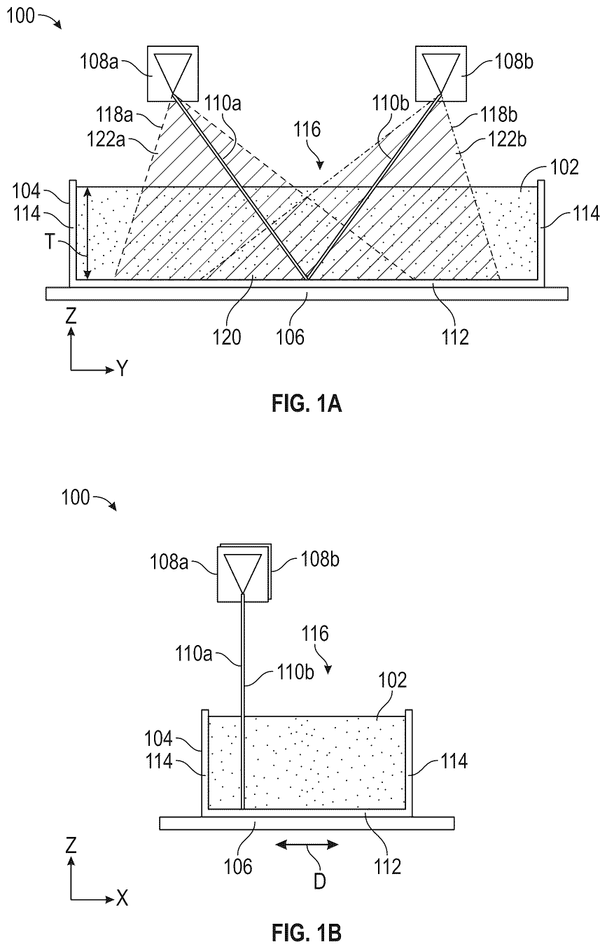

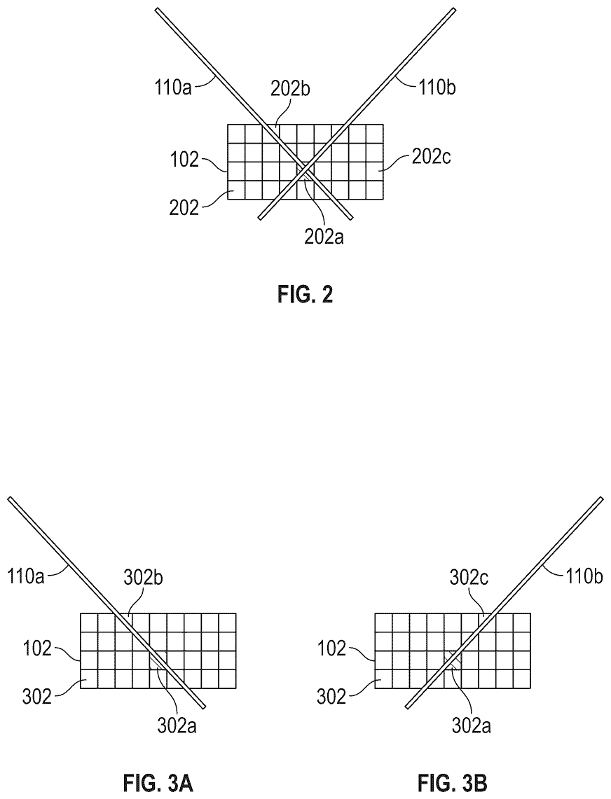

FIGS. 1A-4D illustrate an additive manufacturing system 100 configured in accordance with embodiments of the present technology. Specifically, FIG. 1A is a partially schematic front cross-sectional view of the system 100, FIG. 1B is a partially schematic side cross-sectional view of the system 100, and FIGS. 2-4D illustrate various aspects of the operation of the system 100.

Referring first to FIGS. 1A and 1B together, the system 100 includes a curable material 102 within a reservoir 104 on a platform 106, and a plurality of energy sources 108a, 108b (collectively, “energy sources 108”) that output respective energy beams 110a, 110b (collectively “energy beams 110”). The energy beams 110 can be scanned through the curable material 102 to selectively solidify the curable material 102 to form one or more additively manufactured objects, as described in greater detail below. For example, the system 100 can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

The curable material 102 can be composed of one or more reactive components that change form when exposed to the energy (e.g., electromagnetic energy, acoustic energy, radiation energy) produced by the energy sources 108. The change in form can include, for example, changing from a monomeric form to an oligomeric and/or polymeric form, changing from an amorphous form to a crystalline form, changing from a liquid or semi-liquid form to a solid or semi-solid form, changing from a particulate or filament form to a continuous solid form, or from a non-crosslinked form to a crosslinked form, or combinations thereof.

For example, the curable material 102 can be a resin. The resin can be composed of one or more polymerizable components, such as one or more monomers, oligomers, and/or reactive polymers. The polymerizable components can be any molecule or compound capable of forming bonds with other polymerizable components, thus resulting in a larger molecule with increased molecular weight. In some embodiments, the bond-forming reaction occurs multiple times, such that the molecular weight of the resultant molecule increases with each successive bond-forming reaction. Examples of bond-forming reactions suitable for use with the techniques described herein include, but are not limited to, free radical polymerization, ionic polymerization (e.g., cationic polymerization, anionic polymerization), condensation polymerization, metathesis polymerization, Diels-Alder reactions, photodimerization, carbene formation, nitrene formation, and suitable combinations thereof.

The resin can initially be in a liquid state at room temperature (e.g., 20° C.) or at an elevated temperature (e.g., a temperature within a range from 50° C. to 120° C.). When exposed to energy, the polymerizable components can undergo a polymerization reaction and/or other bond-forming reaction. Exposure to a sufficiently high energy dosage can cause the polymerizable components to polymerize beyond the gel point of the resin, thus causing the resin to solidify (e.g., gel). As described further below, the energy sources 108 can be used to deliver an energy dosage exceeding the threshold dosage for solidifying the resin at selected locations corresponding to the geometry of the object to be formed, while the remaining locations of the resin receive a lower energy dosage and thus do not solidify.

In some embodiments, the polymerizable components (e.g., low molecular weight monomers, oligomers, polymers) form a high modulus phase within a polymerized material. In such embodiments, this phase can provide sufficient strength to the green state object to survive post-processing and/or can direct the final shape of the additively manufactured object. Alternatively, the polymerizable components can form a low modulus phase within the polymerized material or otherwise lower the local modulus of the object.

In some embodiments, the polymerizable components include one or more of the following: an acrylate monomer, a methacrylate monomer, a thiol monomer, a vinyl acetate monomer, a vinyl ether monomer, a vinyl chloride monomer, a vinyl silane monomer, a vinyl siloxane monomer, a styrene monomer, an allyl ether monomer, an acrylonitrile monomer, a butadiene monomer, a norbornene monomer, a maleate monomer, a fumarate monomer, an epoxide monomer, an anhydride monomer, or a hydroxyl monomer. In some embodiments, the polymerizable components include one or more of the following: a free radically polymerizable group, a cationically polymerizable group, or an anionically polymerizable group. In some embodiments, the polymerizable components include one or more reactive functional groups, such as one or more of the following: an acrylate, a methacrylate, an acrylamide, a vinyl group, a vinyl ether, a thiol, an allyl ether, a norbornene, a vinyl acetate, a maleate, a fumarate, a methylenemalonate, a maleimide, an epoxide, a ring-strained cyclic ether, a ring-strained thioether, a cyclic ester, a cyclic carbonate, a cyclic silane, a cyclic siloxane, a hydroxyl, an amine, an isocyanate, a blocked isocyanate, an acid chloride, an activated ester, an oxetane, a Diels-Alder reactive group, a furan, a cyclopentadiene, an anhydride, a group favorable toward photodimerization (e.g., an anthracene, an acenaphthylene, or a coumarin), a group that photodegrades into a reactive species (e.g., Norrish Type 1 and 2 materials), an azide, a derivative thereof, or a combination thereof. Additional examples of polymerizable components that may be used are provided in U.S. Pat. No. 10,495,973 and U.S. Patent Publication Nos. 2021/0147672, 2021/0395420, 2022/0380502, and 2023/0021953, the disclosures of each of which are incorporated by reference herein in their entirety.

In some embodiments, the curable material 102 is or includes a thiol-ene resin. Thiol-ene resins are typically not inhibited by oxygen and thus can be difficult to print using conventional additive manufacturing techniques such as SLA. In contrast, the additive manufacturing processes of the present technology are capable of forming a 3D object in high resolution from thiol-ene resins despite the lack of oxygen inhibition.

In some embodiments, the curable material 102 includes one or more semicrystalline materials. The materials may be liquid or crystalline at the time of printing. Examples of resins including semicrystalline materials are provided in U.S. Patent Publication No. 2021/0147672, the disclosure of which is incorporated by reference herein in its entirety. The present technology can be advantageous for printing semicrystalline materials because the temperature of the material can be raised above the Tₘ value, which may make the material transparent or nearly transparent (e.g., compared to the crystallized form which may scatter light). For example, the reservoir 104 and/or other components of the system 100 can include one or more heating elements to allow for heating of the curable material 102 to a temperature above the Tₘ, as described further below. In contrast, conventional additive manufacturing techniques such as SLA may not be capable of printing semicrystalline materials having high Tₘ values.

In some embodiments, the present technology allows high Tₘ materials such as high Tₘ thermoplastics to be mixed with reactive resins and/or made into reactive polymers, and printed at temperatures above their respective Tₘ values. Residual unsolidified material can be removed from the additively manufactured object in post-processing, e.g., using insolubility in a solvent for crosslinked and/or crystallized regions, and/or melting and flowing of uncrosslinked regions. For some materials (e.g., thiol-ene or other step growth polymerization materials), the Tₘ of the material in the unreacted state is less than the Tₘ of the material in the reacted state. Accordingly, the unreacted material may be liquid at the printing temperature, and may crystallize upon exposure to a certain amount of energy. This approach allows for solidification of the material without requiring covalently crosslinking. Moreover, the printed green state object can be separated from the rest of the resin by allowing the less cured material to flow away while the crystalline areas remain solid.

In some embodiments, the curable material 102 includes a plurality of different resins, such as two, three, four, five, or more resins. Some or all of the resins may be miscible with each other, or some or all of the resins may not be miscible with each other. In some embodiments, the different resins are all initially present in the curable material 102, while in other embodiments, one or more resins can be added to the curable material 102 before, during, and/or after each printing cycle. The resin(s) can be added within the volume of the curable material 102, onto the surface of the curable material 102, or suitable combinations thereof. The resin(s) can be added using any suitable deposition technique, such as extrusion, inkjetting, injection, spraying, pouring, etc. The different resins can have different properties, which can be used to create composite materials in which different portions of the material have different properties (e.g., stiffness, strength, T_{g}). For example, some of the resins can be reactive toward the energy produced by the energy sources 108, while other resins may be unreactive toward the energy produced by the energy sources 108. In such embodiments, the other resins can be reactive toward other energy, such as light, heat, and/or pressure applied after printing (e.g., during post-curing and/or other post-processing).

In some embodiments, the curable material 102 includes one or more additives, such as catalysts, reaction inhibitors, blockers, viscosity modifiers, fillers, fibers, particles, binders, reactive diluents, solvents, pigments and/or dyes, stabilizers, surface-active compounds, surfactants, mold release compounds, biologically active compounds (e.g., pharmaceuticals, enzymes, antibiotics, cells, hormones), inert polymers, inert oligomers, etc., or suitable combinations thereof.

For example, in some embodiments, the curable material 102 includes a catalyst that, when exposed to energy, forms a reactive species that catalyzes a bond-forming reaction. The catalyst can be a photocatalyst that is activated or otherwise created by absorption of light (e.g., infrared light, visible light, or ultraviolet (UV) light). Examples of photocatalysts include, but are not limited to, photoinitiators (e.g., radical initiators), photoacid generators, and photobase generators. In some embodiments, the photoinitiator is activated by a single wavelength of light, while in other embodiments, the photoinitiator may require two or more different wavelengths of light to be activated. In some embodiments, the photoinitiator may require the absorption of one or more photons to become active. In some embodiments, photon upconversion (e.g., two-photon upconversion) is used to create a higher energy photon from two or more lower energy photons.

In some embodiments, the curable material 102 includes a reaction inhibitor to prevent curing of the curable material 102 in locations where curing is not desired. The reaction inhibitor can be a photoactivated inhibitor that is activated by light (e.g., infrared light, visible light, or UV light). Optionally, the reaction inhibitor can be removed from portions of the curable material 102 where curing is desired, e.g., by degrading the reaction inhibitor using light or other energy.

In some embodiments, the curable material 102 includes a blocker that limits the depth of energy penetration into the curable material 102 during the additive manufacturing process. For example, the blocker can be a photoblocker that absorbs the irradiating wavelength responsible for causing photoreactions (e.g., activation of a photocatalyst or photodimerization reaction). In some embodiments, the photoblocker is activated by an energy source, such as light (e.g., spiropyrans and other photochromics that are activated by light and change their absorption). In other embodiments, however, the curable material 102 does not include any blockers.

In some embodiments, the curable material 102 includes a viscosity modifier. The viscosity modifier can be a component that increases the viscosity of the curable material 102 (e.g., a filler, binder, thixotropic agent). Alternatively, the viscosity modifier can be a component that decreases the viscosity of the curable material 102 (e.g., reactive diluent, solvent).

In some embodiments, the curable material 102 includes a filler. The filler can be an organic or inorganic filler, such as fumed silica, core-shell particles, talc, titanium dioxide, sugar, nanocellulose, graphite, carbon black, carbon nanotubes, etc.

In some embodiments, the curable material 102 includes a plurality of fibers. The fibers can be organic fibers or inorganic fibers (e.g., glass fibers). The fibers can be transparent, translucent, or opaque. Optionally, the curable material 102 can be index matched to the fibers. The fibers can have adhesion promoting surfaces, such as reactive chemistry and/or mechanical roughness. The fibers can be placed through the entire curable material 102, or can be placed only in certain regions of the curable material 102 to be fully incorporated into the additively manufactured object, partially incorporated into the object, or not incorporated into the object. The fibers can be randomly distributed within the curable material 102, or can be aligned. For instance, the fibers can be aligned in the long direction (e.g., length) or short direction (e.g., width or height) of the object. In embodiments where the object is a dental appliance such as an aligner, the fibers can be aligned along the long arch of the dental appliance, rather than along the height of the dental appliance. The fibers can be aligned using various techniques. In some embodiments, the fibers are aligned by extruding the curable material 102 with the fibers in the desired alignment direction. Optionally, the fibers can be entrapped in a viscous resin, and the resin can be moved along the desired alignment direction, which can cause the fibers to align with the direction of resin movement. The resin movement may be during extrusion or deposition of the resin, or can be done mechanically by moving a solid object through the resin containing the fibers.

In some embodiments, the curable material 102 includes a plurality of particles. The particles can be organic particles or inorganic particles. The particles can be transparent, translucent, or opaque. Optionally, the curable material 102 can be index matched to the particles. The particles can have adhesion promoting surfaces, such as reactive chemistry and/or mechanical roughness. The particles can be placed through the entire curable material 102, or can be placed only in certain regions of the curable material 102 to be fully incorporated into the additively manufactured object, partially incorporated into the object, or not incorporated into the object. The particles can be dispersed or aggregated within the curable material 102.

In some embodiments the curable material 102 includes a binder. The binder can be a high molecular weight polymer that is added to the curable material 102 to increase the viscosity and/or to enhance various material properties after curing, such as polymethylmethacrylate, acrylonitrile butadiene styrene (ABS), etc.

In some embodiments, the curable material 102 includes a reactive diluent. The reactive diluent can decrease the viscosity of the curable material 102, while also reacting with one or more other components to form part of the object. For example, reactive diluents can be combined with oligomers and/or reactive polymers within the curable material 102.

In some embodiments, the curable material 102 includes a solvent. The solvent can decrease the viscosity of the curable material 102 and/or compatibilize two or more components of the curable material 102.

In some embodiments, the curable material 102 includes a pigment and/or dye. The pigment and/or dye (e.g., titanium dioxide, red dye #40, carbon black) can add color and/or other function to the object.

In some embodiments, the curable material 102 includes a stabilizer configured to stabilize one or more components (e.g., to prevent precipitation, aggregation, degradation). For example, the stabilizer can be an emulsifier that stabilizes the components of an emulsion.

In some embodiments, the curable material 102 includes a surface-active compound. The surface-active compound can enhance wetting or adhesion of the curable material 102 and/or object to another surface. Alternatively or in combination, the surface-active compound can facilitate debonding of the curable material 102 and/or object to another surface. Examples or surface-active compounds include, but are not limited to, wax, silicone compounds, silanes, fluorinated compounds, etc.

Optionally, some or all of the components of the curable material 102 can serve more than one function within the curable material 102 and/or the additively manufactured object. For example, reactive diluents can be monomers and can also serve as viscosity modifiers; carbon black can be a pigment and also a photoblocker; and so on.

In some embodiments, the curable material 102 includes at least one solid component, such as an electronics package (e.g., sensor), battery, metal component (e.g., metal wire, metal sheet), plastic component (e.g., plastic wire, plastic sheet), reinforcement structure, support structures (e.g., temporary or permanent support structures), handles (e.g., e.g., temporary or permanent handles), components that can attach to other components (e.g., hooks, buttons), etc. The solid component may or may not become a permanent part of the additively manufactured object. Additional examples of solid components that can be added to the curable material 102 are provided in U.S. Patent Publication No. 2021/0220087, U.S. Patent Publication No. 2022/0110717, and U.S. Provisional Application No. 63/381,097, the disclosures of which are incorporated by reference herein in their entirety.

The solid component can be placed on or into the curable material 102 at a desired location manually by a human operator, by a robotic arm, or using any other suitable technique. The solid component can be held on or within the curable material 102 at the desired location by a supporting structure (e.g., by the reservoir 104 and/or the platform 106) and/or by the viscosity of the curable material 102. In some embodiments, the solid component is placed into the curable material 102 before energy is applied to the curable material 102 by the energy sources 108. Optionally, the curable material 102 can alternatively be added after placement of the solid component at a desired location.

When a solid component is present in the curable material 102, the solid component may or may not be fully transparent to the energy produced by the energy sources 108. In embodiments where the solid component is not fully transparent to the energy, the curable material 102 below the solid component can be “a shadow region” that may be difficult to cure or may not be cured. In such embodiments, the presence of a shadow region may not cause any issues as long as the solid component is in a fixed position and the uncured shadow region is contained within a cured volume of the curable material 102. After printing, the uncured shadow region can be cured during a post-cure process, if desired. Optionally, another curable material that is unreactive to the energy from the energy sources 108a can be placed in the shadow region, and can be activated either during deposition or after the print by another energy source and/or over time. Alternatively or in combination, chemistries that can cure into the shadow regions such as cationic reactions can be used.

The solid components themselves may or may not be fully encapsulated by the curable material 102. For instance, the solid component can be located within the interior of the additively manufactured object or can be located at the surface of the additively manufactured object. In some embodiments, the solid component is present in the curable material 102 and purposely leaves an unreacted shadow region that is not encased in cured material.

In some embodiments, certain types of solid components are present in the curable material 102 that are not cured into the additively manufactured object. For example, the solid component can be a handle for the object, or a sheet at the bottom of the reservoir 104 for supporting the object, which may be useful for post-processing of the object. In some embodiments, the handle is used to facilitate the removal of the object from the remaining curable material 102, and can facilitate further processing such as providing a structure for gripping and moving the object to other stations such as solvent washing, centrifuging, etc. Moreover, the solid component may not be attached to the object. For example, a porous structure (e.g., a metal or plastic grid or basket) may be initially present in the curable material 102; after printing, the porous structure can be lifted out of the curable material 102, thus separating the object from the remaining curable material 102 and/or facilitating transport of the object for further processing, such as centrifugation, solvent washing, post-cure light exposure, post-cure heat exposure, post-cure chemical modification, etc.

In some embodiments, the curable material 102 (e.g., resin) is used at a selected printing temperature. The printing temperature can be room temperature (e.g., 25° C.), can be an elevated temperature (e.g., at least 30° C., 40° C., 50° C., 60° C., 70° C., 80° C., 90° C., 100° C., 110° C., 120° C., 150° C., or 200° C.), or can be a lower temperature (e.g., no more than 20° C., 10° C., 0° C., −10° C., −20° C., −30° C., −40° C., −50° C., or −60° C.). In some embodiments, the printing temperature is within a range from −60° C. to 0° C., 0° C. to 100° C., 100° C. to 120° C., 120° C. to 150° C., 150° C. to 200° C., or greater than 200° C.

The printing temperature can be controlled using one or more heating elements and/or one or more cooling elements. The heating and/or cooling elements can be coupled to or part of the reservoir 104, or can be another component of the system 100, as described further below. In some embodiments, the curable material 102 is heated or cooled from an initial temperature (e.g., room temperature) to the printing temperature in no more than 10 minutes, 5 minutes, 2 minutes, 1 minutes, 30 seconds, or 10 seconds. Optionally, the curable material 102 is maintained at the printing temperature for no more than 10 minutes, 5 minutes, 2 minutes, 1 minutes, 30 seconds, or 10 seconds. Optionally, the curable material 102 can be returned from the printing temperature to the initial temperature in no more than 10 minutes, 5 minutes, 2 minutes, 1 minutes, 30 seconds, or 10 seconds.

In some embodiments, the entirety of the curable material 102 is maintained at the same temperature. Alternatively, certain portions of the curable material 102 can be at a different temperature than other portions of the curable material 102, which can be used to create object portions with different material properties. In such embodiments, the temperature of different portions of the curable material 102 can be selectively controlled, such as by selectively applying energy to certain portions of the curable material 102 (e.g., using infrared light, microwaves, placement of heating elements at specific locations), and/or by selectively cooling certain portions of the curable material 102 (e.g., using cold fingers, thermoelectric coolers (TECs), cold air streams, CO₂ snow jets). Additional examples of techniques for temperature control are provided in U.S. Pat. No. 11,661,468, the disclosure of which is incorporated by reference herein in its entirety.

The curable material 102 can have any suitable viscosity at the printing temperature, such as a viscosity within a range from 10 cP to 100 cP, 100 cP to 1000 cP, 1000 cP to 10,000 cP, 10,000 cP to 100,000 cP, or 100,000 cP to 1,000,000 cP. In some embodiments, the curable material 102 is a solid at the printing temperature. In some embodiments, the curable material 102 is thixotropic and/or shear-thinning.

In some embodiments, the curable material 102 is optically transparent or translucent. For example, the curable material 102 can be at least 50%, 60%, 70%, 80%, 90%, 95%, or 99% (e.g., at a 1 cm path length) in one or more wavelengths of energy produced by the energy sources 108.

The reservoir 104 can be a vat, tank, trough, tray, or other container suitable for holding the curable material 102. The reservoir 104 can be sufficiently large such that the interior volume of the reservoir 104 is equal to or greater than the volume of the object(s) to be fabricated. For instance, the height of the reservoir 104 can be greater than or equal to the maximum height of the object(s), the length of the reservoir 104 can be greater than or equal to the total length of the object(s), and the width of the reservoir 104 can be greater than or equal to the total width of the object(s). Although the reservoir 104 is depicted as having a rectangular cross-sectional shape, in other embodiments, the reservoir 104 can have a different cross-sectional shape, such as a square, cylindrical, hemicylindrical, trapezoidal, etc. In some embodiments, the shape of the reservoir 104 mimics the shape of the object to be printed.

In the illustrated embodiment, the reservoir 104 includes a bottom wall 112 and a plurality of sidewalls 114. The bottom wall 112 and/or sidewalls 114 can be optically transparent to the energy beams 110, or can be opaque to the energy beams 110. In some embodiments, the bottom wall 112 and/or sidewalls 114 are highly absorbing to the energy beams 110 such that little or no energy is reflected from or otherwise directed out of the reservoir 104 and/or reflected back into the reservoir 104. Alternatively or in combination, the energy beams 110 can be efficiently coupled out of the reservoir 104 by the shape of the reservoir 104 itself and/or via surface coatings (e.g., antireflective coatings).

The reservoir can also include an opening 116 at the upper portion of the reservoir 104, such that the upper surface of the curable material 102 is exposed and directly accessible by the energy beams 110 from the energy sources 108. Alternatively, the reservoir 104 can include an upper wall such that the curable material 102 is completely enclosed within the reservoir 104. In such embodiments, the upper wall can be optically transparent to allow the energy beams 110 to pass through. The upper wall can optionally include an antireflective coating to enhance energy transmission through the upper wall.

In some embodiments, the upper wall is a liquid, such as an oil (e.g., silicon oil), wax, water, or a resin with or without initiator components (e.g., the surface layer of resin may include initiator components that are active via heat and/or a wavelength different than the curable material 102). The liquid can be insoluble in the curable material 102. The liquid may restrict the diffusion of oxygen to facilitate curing at the surface of the curable material 102. The liquid may be of sufficiently low viscosity to flow and level to provide a smooth level surface for transmitting the energy beams 110 therethrough. The liquid may be of a different refractive index than the curable material 102. In some embodiments, for example, the refractive index of the liquid is lower than the refractive index of the curable material 102, e.g., to facilitate coupling of the energy beams 110 into the curable material 102. Alternatively, the refractive index of the liquid may be higher than the refractive index of the curable material 102, e.g., to restrict certain angles of the energy beams 110 from coupling into the curable material 102.

In some embodiments, the atmosphere above the surface of the curable material 102 may be inert to the reaction within the curable material 102, e.g., to facilitate curing at the surface of the curable material 102 when desired. For example, if free radical polymerization is used to cure the curable material 102, then an atmosphere of nitrogen, carbon dioxide, argon, xenon, or other gas that does not react with free radicals can be used. As another example, if cationic polymerization is used to cure the curable material 102, then an atmosphere of air with little to no water and/or alcohols can be used.

Optionally, in embodiments where the curable material 102 is highly viscous and exhibits little or no flow after deposition, some or all of the sidewalls 114 of the reservoir 104 can be omitted (e.g., the reservoir 104 can include only two lateral sidewalls 114 or can include no sidewalls 114). Accordingly, the reservoir 104 can be a platform, sheet, stage, or other generally planar substrate that supports the curable material 102 on a surface, rather than containing the curable material 102 within an interior cavity.

The curable material 102 can be deposited into the reservoir 104 as one or more layers. The layers can each have a respective layer thickness T, which can be the same or different for different layers. The layer thickness T can be within a range from 1 μm to 10 μm, 10 μm to 100 μm, 100 μm to 1 mm, 1 mm to 1 cm, or 1 cm to 10 cm, or can be greater than 10 cm. In some embodiments, the layer thickness T is greater than or equal to the height of the additively manufactured object to be formed, such that a single layer of the curable material 102 is deposited in the reservoir 104. In other embodiments, however, the layer thickness T can be less than the height of the object, such that multiple layers of the curable material 102 are sequentially deposited in the reservoir 104 to form the object. The layer thickness T can be greater than layer thicknesses used in conventional additive manufacturing processes such as SLA. Moreover, unlike conventional additive manufacturing processes such as SLA, the layer thickness T can be greater than the resolution of the system 100, which may correspond to the minimum voxel size of the system 100. For instance, the minimum voxel size of the system 100 (e.g., minimum voxel height) can be less than or equal to 200 μm, 100 μm, 50 μm, 20 μm, 10 μm, 5 μm, or 1 μm. In some embodiments, the layer thickness T is a factor of 2, 3, 4, 5, 10, 100, or 1000 times greater than the minimum voxel height.

In embodiments where the curable material 102 scatters and/or absorbs the energy beams 110, printing in layers can keep the resolution of the printed object within acceptable limits. However, since the layers for the present technology can be greater than the voxel height, the overall printing process can be faster than in conventional additive manufacturing modalities. In some instances, as the absorbance and/or scattering increases for a curable material 102, the layer height may decrease to be closer to or equal to the voxel height.

In some embodiments, the reservoir 104 includes one or more temperature control elements, which can be used to adjust the temperature of the curable material 102 to a desired temperature as described elsewhere herein. For instance, the temperature control elements can include one or more heating elements, such as heaters, hot plates, heat lamps, or heated fluids. Alternatively or in combination, the temperature control elements can include one or more cooling elements, such as cold fingers, TECs, or cooled fluids. The temperature control elements can be located at any suitable portion of the reservoir 104, such as on or within the bottom wall 112, on or within a sidewall 114, within the interior of the reservoir 104, positioned proximate to the opening of the reservoir 104, or suitable combinations thereof.

Alternatively or in combination, the system 100 can include one or more temperature control elements that are separate from the reservoir 104 but are sufficiently close to the reservoir 104 to control the temperature of the curable material 102. For instance, the system 100 can include a separate energy source that heats the curable material 102 via infrared energy, electrical energy, microwave energy, etc. In some embodiments, infrared energy is controlled such that selective heating of sections of the curable material 102 can be achieved (e.g., 2D or 3D selective heating), e.g., using the techniques described in U.S. Pat. No. 11,661,468, the disclosure of which is incorporated by reference herein in its entirety. The temperature control elements can also be positioned on or within the platform 106 supporting the reservoir 104.

In some embodiments, the reservoir 104 includes one or more ports for introducing the curable material 102 into the reservoir 104 and/or for draining the curable material 102 out of the reservoir 104. The port(s) can be located at any suitable part of the reservoir 104, such as the bottom wall 112, a sidewall 114, or combination thereof. Optionally, the system 100 can include additional components to facilitate removal of curable material 102 from the reservoir 104 after the additive manufacturing process is complete, such as a source of compressed gas to push the curable material 102 out of the reservoir 104, and/or a source of a solvent to flush the curable material 102 out of the reservoir 104 and/or off the surfaces of the object. In some embodiments, a second curable material (e.g., a second resin) is introduced into the reservoir 104 after the curable material 102 is removed or to displace the curable material 102 from the reservoir 104 and/or any other residual materials (e.g., gases, solvents). In such embodiments, the second curable material can be used to fabricate additional portions of the object and/or other additively manufactured objects that are not part of the previously fabricated object.

The reservoir 104 can be positioned on a platform 106, which can be a stage, conveyor belt, carrier film, or other structure having a generally flat surface for supporting the reservoir 104. The reservoir 104 can be a separate component that is placed on the platform 106 (e.g., manually or via a robotic arm), or can be an integrally formed part of the platform 106. The platform 106 can be configured to advance the reservoir 104 relative to the energy sources 108 along one or more movement directions D (FIG. 1B) to form successive portions of the additively manufactured object, as described further below. In the illustrated embodiment, the movement direction D is along the X-axis of the system 100, while in other embodiments, the movement direction D can be along a different direction. Alternatively or in combination, the energy sources 108 can be advanced relative to the reservoir 104, e.g., using motors, conveyor belts, moving stages, a robotic arm, etc.

The energy sources 108 are configured to output energy that causes curing of the curable material 102 (e.g., via polymerization and/or other bond-forming reactions as described herein). Each energy source 108 can independently output any suitable type of energy, such as electromagnetic energy (e.g., infrared light, visible light, UV light, microwaves), acoustic energy, and/or radiation energy (e.g., alpha radiation, beta radiation, neutron radiation). For example, the energy sources 108 can be light sources that each respectively produce one or more wavelengths of light, such as lasers, LEDs, broadband light sources (e.g., lamps), etc. In embodiments where a single energy source 108 outputs multiple wavelengths of light, the multiple wavelengths can be produced using optical elements such as beam combiners, dichroic mirrors, holographic elements, asymmetric lenses and/or mirrors, light sources capable of changing wavelengths, broadband light sources combined with filters, or suitable combinations thereof. The wavelength(s) can be selected to trigger a chemical reaction within the curable material 102, as described herein. Some or all of the energy sources 108 can output the same type of energy (e.g., energy having the same wavelength), or some or all of the energy sources 108 can output different types of energy (e.g., energy having different wavelengths). Although the illustrated embodiment shows two energy sources 108a, 108b, in other embodiments, the system 100 can include any suitable number of energy sources 108, such as three, four, five, or more energy sources 108, as described further below.

The energy produced by the energy sources 108 can be in the form of energy beams 110. The energy beams 110 can be monochromatic and/or coherent light beams, for example. Although the energy beams 110 are depicted as having constant diameters, in other embodiments, some or all of the energy beams 110 can instead be converging or diverging beams that have variable diameters, as discussed further below. The energy beams 110 can have any suitable beam shape, such as circular, oval, square, rectangular, etc. Optionally, the energy sources 108 can include optical elements (e.g., mirrors, lenses, prisms, filters, beam splitters) to control the direction and/or characteristics (e.g., wavelength, phase, intensity, diameter, shape) of the corresponding energy beam 110.

The energy sources 108 can be positioned above the reservoir 104 so as to direct the energy beams 110 downward through the opening 116 and into the curable material 102. The energy sources 108 can be at the same height (e.g., Z-position) above the reservoir 104, or can be at different heights above the reservoir 104. As best seen in FIG. 1A, the energy sources 108 can be arranged in a linear array lying within a YZ-plane of the system 100 (the energy sources 108 are depicted as being slightly offset in the X- and Z-directions in FIG. 1B merely for illustrative purposes). The energy sources 108 can be spaced apart from each other along the Y-axis by any suitable distance, such as by a distance within a range from 0.5 cm to 1 cm, 1 cm to 2 cm, 2 cm to 5 cm, 5 cm to 10 cm, or 10 cm to 20 cm, and/or a distance greater than 20 cm. The distance between the energy sources 108 can be dictated based on the size of the object being printed, the desired resolution for the printed object, the size of the reservoir 104 and/or platform 106, and/or other relevant considerations. For example, the distance between neighboring energy sources 108 can be equal to the total width (Y-dimension) of the reservoir 104 divided by the number of energy sources 108. In other embodiments, however, the energy sources 108 can be arranged differently, as described further below.

As best seen in FIG. 1A, each energy source 108 can be configured to scan its respective energy beam 110 through the curable material 102. For example, the first energy source 108a can scan the first energy beam 110a through a first scanning region 118a, and the second energy source 108b can scan the second energy beam 110b through a second scanning region 118b. Each scanning region 118 can be a 2D shape that passes through a plane within the volume of the curable material 102. The scanning regions 118 can lie within the same plane or can lie in different planes, depending on the position and configuration of the energy sources 108. In the illustrated embodiment, for example, the energy beams 110 are swept within a YZ-plane of the system 100 along the Y-axis, such that the scanning regions 118 lie within the YZ-plane and are orthogonal to the X-axis of the system 100 (which can be the movement direction D of the reservoir 104). In other embodiments, however, one or more of the scanning regions 118 can instead be at an angle relative to the X-axis, such as an angle of at least 10°, 20°, 30°, 40°, 50°, 60°, 70°, 80°, 90°, 100°, 110°, 120°, 130°, 140°, 150°, 160°, or 170°.

For example, as shown in FIG. 1A, the scanning regions 118 can be fan-shaped regions produced by sweeping each of the energy beams 110 along respective arcs. Stated differently, each energy source 108 can independently rotate its respective energy beam 110 through a range of angles relative to the curable material 102. The angular range of the rotation can be at least 10°, 20°, 30°, 40°, 50°, 60°, 70°, 80°, 90°, 100°, 110°, 120°, 130°, 140°, 150°, 160°, 170°, or 180°. In some embodiments, the angular range is from 10° to 90°, 90° to 120°, or from 120° to 180°. Alternatively or in combination, the scanning regions 118 can be produced through other techniques, such by translating the energy beams 110 (e.g., along the X- and/or Z-directions).

During the additive manufacturing process, each energy beam 110 is scanned through its respective scanning region 118 multiple times to form successive portions (e.g., cross-sections, slices, and/or layers) of the additively manufactured object. Each energy beam 110 can be scanned through its respective scanning region 118 at any suitable rate, also known as a “sweep rate” or “scan rate.” For instance, the sweep rate of an energy beam 110 can be at least 1 rad/s, 180 rad/s, 1800 rad/s, or 18,000 rad/s. Alternatively or in combination, the sweep rate can be at least 100 Hz, 200 Hz, 500 Hz, 1 kHz, 2 kHz, or 5 kHz.

The energy sources 108 can be configured in many different ways to allow for scanning of the energy beams 110. In some embodiments, some or all of the energy sources 108 direct their respective energy beam 110 onto an optical element that moves (e.g., rotates and/or translates) to scan the energy beam 110 through the respective scanning region 118. For instance, the optical element can be a rotating optical element, such as a rotating mirror, rotating lens, or rotating prism. The rotating optical element can be a polygonal structure (e.g., a polygonal mirror) with a plurality of facets that receive and direct the energy beam 110 toward the curable material 102, such as three, four, five, six, seven, eight, nine, 10, or more facets. As the polygonal structure rotates, the energy beam 110 can be deflected along the length of each facet in succession. At any one time, one of the facets can receive and deflect the energy beam 110 toward the curable material 102. As the facet changes its rotational position due to rotation of the polygonal structure, the angle of incidence of the energy beam 110 with respect to the facet will change, thus altering the angle of deflection and thus the angle of the energy beam 110 relative to the curable material 102, thereby scanning the energy beam 110 along an arc through the scanning region 118. The sweep length and rate of the energy beam 110 can thus depend on the face length and rotation rate of the polygonal structure. In some embodiments, the polygonal structure rotates in a single direction (e.g., clockwise or counterclockwise), such that the energy beam 110 is always scanned in single direction (e.g., from left to right along the Y-axis, or from right to left along the Y-axis). In other embodiments, the rotating polygonal structure can rotate in multiple directions (e.g., clockwise and counterclockwise) to allow for scanning of the energy beam 110 in multiple directions (e.g., back and forth along the Y-axis).

Alternatively or in combination, other approaches can be used to scan the energy beam 110, such as a galvo motor scanner system or other energy directing system, and/or by movement of the energy sources 108 relative to the curable material 102. For instance, some or all of the energy sources 108 can be rotated (e.g., about the X- and/or Y-axis) and/or translated (e.g., along the X- and/or Z-axis) to scan the respective energy beams 110 through the curable material 102. Each energy source 108 can be independently movable, or the energy sources 108 can be part of a single movable assembly.

In some embodiments, the energy sources 108 are or include laser sources that produce laser beams. Alternatively, a single laser source can be used as the energy sources 108, and an optical element (e.g., beam splitter, prism, holographic element) can be used to create multiple laser beams. The laser beams can be scanned using one or more movable optical elements (e.g., a rotating polygonal mirror) as described herein. Optionally, the laser beams can have coherence lengths that allow for stable interference patterns to be generated when the laser beams are crossed. A stable interference pattern can be sufficiently stable in spatial location and phase for the curable material 102 to cure in such a manner as to record the interference pattern spatially. Recording of the interference pattern can occur by a higher reaction rate of the curable material 102 in the areas of constructive interference compared to areas of destructive interference. In some embodiments, the recorded interference patterns are detected as changes in refractive index, by the formation of optical gratings, and/or by the formation of holograms. The use of two or more laser beams as described herein can provide the ability to control the shape, pattern, size, and/or direction of the interference pattern (also known as “multibeam holography”). This approach can be used in embodiments where the curable material 102 can form gratings and/or regions having different material properties. For example, the curable material 102 can be a resin for volumetric holographic printing. As another example, the curable material 102 can include any of the materials described in U.S. Pat. No. 11,434,316, the disclosure of which is incorporated by reference herein in its entirety.

In some embodiments, the energy sources 108 are or include LEDs, which can be individual LED units or part of a larger LED array. The light beams from the LEDs can be scanned using one or more movable optical elements (e.g., a rotating polygonal mirror) as described herein. Optionally, an optical system (e.g., a lens and/or mirror system) can be used to direct the light from the LEDs at various angles relative to the curable material 102 (e.g., in X and/or Y directions). In some embodiments, the LEDs are part of a rotating LED array, such as a cylindrical array in which the LEDs are arranged on the outer surface of the cylinder and face outwards. The rotating LED array can spin about one or more axes to scan the light beams, such as about the X- and/or Y-axis of the system 100. Optionally, a plurality of rotating LED arrays can be used, either alone or in combination with other types of light sources.

In some embodiments, the energy sources 108 are or include broadband light sources. The light produced by the broadband light sources can be modified using one or more filters (e.g., cut on filters, cut off filters, bandpass filters, dichroic filters). The light produced by the broadband light sources can be scanned through the curable material 102 using any of the techniques described herein.

In some embodiments, the energy sources 108 are or include a digital micromirror device (DMD). Light from a light source (e.g., a laser) can be directed onto the DMD, and the individual mirrors of the DMD can be individually controlled to produce a light beam. In some embodiments, the light has a coherence length suitable for creating interference patterns in the curable material 102 that can be recorded by reactive chemistry, as described elsewhere herein.

The scanning regions 118 produced by the energy sources 108 can overlap each other at one or more locations. For instance, as shown in FIG. 1A, the first scanning region 118a overlaps the second scanning region 118b at an overlap region 120, such that both the first energy beam 110a and the second energy beam 110b can reach the locations within the overlap region 120. The size and location of the overlap region 120 can be determined based on various parameters, such as the locations of the energy sources 108, the sizes of the energy beams 110, the shapes of the energy beams 110, the movement directions (e.g., rotation directions) of the energy beams 110, and/or the movement ranges (e.g., angular ranges) of the energy beams 110. Optionally, the first scanning region 118a can include a nonoverlap region 122a that is accessible by the first energy beam 110a but not by the second energy beam 110b; and/or the second scanning region 118b can include a nonoverlap region 122b that is accessible by the second energy beam 110b but not by the first energy beam 110a.

In some embodiments, the curable material 102 is configured to solidify when the energy dosage received at a particular location in the curable material 102 (e.g., a voxel) is greater than or equal to a threshold dosage. The energy dosage received at a location can be a function of the intensity and exposure time of the energy received at that location. Application of an energy dosage greater than or equal the threshold dosage can cause curing (e.g., polymerization) of the curable material 102 past the gel point of the curable material 102, thus causing the curable material 102 to become solid at that location. Application of energy dosage less than the threshold dosage may cause no curing of the curable material 102, or may cause some curing of the curable material 102 but not enough to exceed the gel point of the curable material 102, such that the curable material 102 remains in a liquid state. Accordingly, solidification of the curable material 102 can occur when a combined energy dosage delivered by the energy sources 108 is greater than or equal the threshold dosage for solidification of the curable material 102; and the curable material 102 can remain liquid if the combined energy dosage delivered by the energy sources 108 is less than the threshold dosage.

In some embodiments, the curable material 102 may be solidified at a particular location only when sufficient energy is delivered to that location by both of the energy sources 108, and may not solidify at that location when energy is delivered to that location by a single energy source 108 and/or when insufficient energy is delivered to that location by both of the energy sources 108. Stated differently, the maximum energy dosage produced by a single energy source 108 may be less than the threshold dosage for solidifying the curable material 102, whereas the combined energy dosage produced by both energy sources 108 can be greater than or equal to the threshold dosage, depending on the intensity and/or exposure time of each energy source 108.

FIG. 2 is a partially schematic diagram showing selective solidification of a curable material 102 using multiple energy beams 110, in accordance with embodiments of the present technology. The curable material 102 can be divided into a plurality of voxels 202. As shown in FIG. 2, the energy beams 110 can simultaneously apply energy to a voxel 202a to deliver a combined energy dosage that is greater than or equal to the threshold dosage for solidifying the curable material 102, thereby causing the curable material 102 to become a solid cured material at the voxel 202a. In contrast, voxels 202 that only receive energy from a single energy beam 110 (e.g., voxel 202b) or that do not receive any energy (e.g., voxel 202c) may remain unsolidified.

FIGS. 3A and 3B are partially schematic diagrams showing selective solidification of a curable material 102 using multiple energy beams 110, in accordance with embodiments of the present technology. The curable material 102 can be divided into a plurality of voxels 302. In the illustrated embodiment, the energy beams 110 can sequentially apply energy to a voxel 302a, in that the first energy beam 110a applies energy to the voxel 302a for a first time period (FIG. 3A), followed by the second energy beam 110b applying energy to the voxel 302a for a second time period (FIG. 3B). The combined energy dosage delivered to the voxel 302a by the energy beams 110 over the first and second time periods can be greater than or equal the threshold dosage for solidifying the curable material 102, thereby causing the curable material 102 to become a solid cured material at the voxel 302a. In contrast, voxels 302 that only receive energy from one of the energy beams (e.g., voxels 302b, 302c) or that do not receive any energy may remain unsolidified.

Referring again to FIGS. 1A and 1B, the additively manufactured object(s) can be formed from the curable material 102 by selectively solidifying the curable material 102 using the energy beams 110. Specifically, the object(s) can be formed within the overlap region 120, since the overlap region 120 corresponds to the locations where the energy beams 110 are capable of delivering a combined energy dosage to solidify the curable material 102. Moreover, the curable material 102 can be selectively solidified only at certain locations within the overlap region 120 corresponding to the desired object geometry by controlling the scanning parameters of each energy beam 110 as the energy beam 110 is swept through its respective scanning region 118. The scanning parameters can include one or more of the following: whether the energy beam 110 is on or off, the intensity of the energy beam 110, and/or the sweep rate of the energy beam 110 (which can affect the exposure time produced by the energy beam 110). The scanning parameters can be varied for different positions of the energy beam 110 within the scanning region 118. For instance, the energy beam 110 can be off when the energy beam 110 is at one angular position, and can be on when the energy beam 110 is at another angular position; the energy beam 110 can have a first intensity when the energy beam 110 is at one angular position, and can have a second, different intensity when the energy beam 110 is at another angular position; and so on.

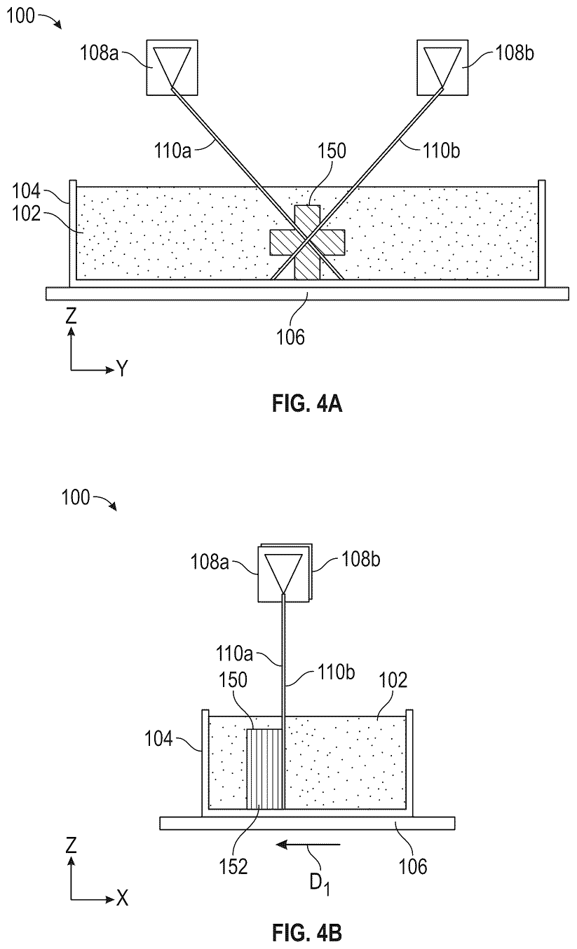

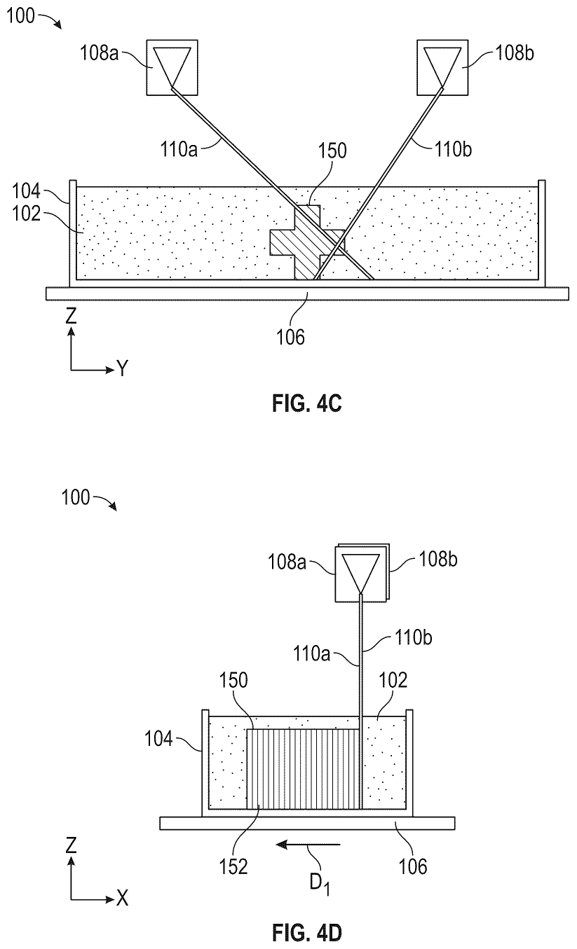

For example, FIGS. 4A and 4B are partially schematic front and side cross-sectional views, respectively, of the system 100 during a stage of operation for forming an additively manufactured object 150, in accordance with embodiments of the present technology. The object 150 can be formed by using the energy beams 110 to selectively solidify one or more locations within the curable material 102 that correspond to the geometry of a particular portion (e.g., cross-section) of the object 150 (referred to herein as “object locations”). To solidify the curable material 102 at an object location, the scanning parameters of the energy sources 108 can be controlled so that the energy sources 108 apply a sufficiently high combined energy dosage to the object location, e.g., by applying energy to the same location simultaneously or sequentially. Conversely, to prevent solidification of the curable material 102 at a location that is not an object location, the scanning parameters of the energy sources 108 can be controlled so that one or both energy beams 110 are off when they pass through that location, or so that if both energy beams 110 are on when they pass through that location, the combined energy dosage delivered to that location by the energy beams 110 is below the threshold dosage (e.g., due to insufficient total energy intensity and/or insufficient total exposure time).

As best seen in FIG. 4B, the reservoir 104 can be advanced along relative to the energy sources 108 along a movement direction DI as the energy beams 110 are repeatedly scanned through their respective scanning regions 118 (e.g., as depicted in FIG. 1A), thus forming successive portions 152 of the object 150. In the illustrated embodiment, for example, the scanning regions 118 are located in the YZ-plane of the system 100, such that the object portions 152 are YZ cross-sections that are successively formed from left to right as the reservoir 104 moves left along the X-axis. The movement of the reservoir 104 (e.g., movement speed and/or direction) can be coordinated with the scanning of the energy beams 110 so that the YZ cross-sections of the object 150 are formed at the appropriate locations along the X-axis to build up the desired 3D shape of the object 150.

Referring next to FIGS. 4C and 4D, which are partially schematic front and side cross-sectional views, respectively, of the system 100 during a subsequent stage of operation for forming the object 150, the process of scanning the energy beams 110 and advancing the reservoir 104 can be repeated until the entire object geometry has been formed. The object 150 can then be removed from the reservoir 104 for further processing.

The operation of the system 100 of FIGS. 1A-4D can be controlled by a controller (not shown) that is operably coupled to the various components of the system 100 (e.g., the energy sources 108, reservoir 104, platform 106, and/or any temperature control elements). The controller can be or include a computing device including one or more processors and memory storing instructions for performing the operations described herein. For example, the controller can control the scanning parameters of the energy sources 108 and movement of the reservoir 104 to selectively solidify the curable material 102 to form the object 150 from a plurality of successive portions 152, as described herein. As another example, the controller can control the heating and/or cooling produced by one or more temperature control elements to adjust the temperature of the curable material 102.

In some embodiments, the controller controls the operations of the system 100 using a set of fabrication instructions that specify the scanning parameters of the energy sources 108. The fabrication instructions can also specify the movement speed and/or direction of the reservoir 104 to form one or more additively manufactured objects, or the movement speed and/or direction can be assumed to be constant. The fabrication instructions can be generated using a software algorithm, which may be implemented by the controller, a separate computing device (e.g., a computing device of a treatment planning system), or a combination thereof. Additional details of software algorithms that can be used are provided below.

The configuration of the system 100 shown in FIGS. 1A-4D can be modified in many ways. For instance, the configuration of one or more components of the system 100 can be varied. In some embodiments, one or more of the energy sources 108 can be part of the reservoir 104 and/or the platform 106, rather than being separate from these components. One or more energy sources 108 can be configured to direct energy through the sidewall 114 of the reservoir 104, in which case the sidewall 114 can be made from an optically transparent material. Alternatively or in combination, one or more energy sources 108 can be configured to direct energy through the platform 106 and the bottom wall 112 of the container, in which case the platform 106 and bottom wall 112 can be made from optically transparent materials. Optionally, the system 100 can include at least one energy source 108 that illuminates a larger area (e.g., a lamp), rather than outputting a focused beam. Such an energy source 108 can be used to evenly cure one or more sections of the curable material 102, which can be used to raising the extent of cure for any object portions within those sections beyond the gel point of the curable material 102.

The system 100 can include additional components not shown in FIGS. 1A-4D. In some embodiments, the reservoir 104 includes a liner covering the interior surface of the bottom wall 112 and/or sidewalls 114 that can be removed from the reservoir 104. The liner can be used to transport the curable material 102 and/or the additively manufactured object to another location for additional processing, such filtering of the curable material 102 to remove the object. The liner can include a cover window proximate to the opening 116 of the reservoir 104 to create an enclosed volume. The liner can optionally include one or more ports to allow for introduction and/or removal of the curable material 102. The liner can be made out of any suitable material, such as plastic, glass, ceramic, wood, or metal. The liner can be transparent, semitransparent, or opaque to the energy from the energy sources 108.

In some embodiments, the system 100 includes components configured for curing of the curable material 102 at selected locations via triple fusion upconversion. Triplet fusion upconversion can use high intensity light (e.g., red light) to produce annihilator triplets which combine to release a higher energy photon (e.g., a blue photon). This emitted photon can then cure the curable material 102 in a small region. This process can achieve very high dimensional accuracy during volumetric additive manufacturing (VAM) which, when combined with the upconversion techniques described herein, may allow for higher accuracy and faster prints by using standard VAM to cure large volumes and then using upconversion to cure more detailed regions. Alternatively, upconversion techniques can be used to cure the whole object at slower speeds. In some embodiments, the upconversion technique uses two photoinitiators that are sensitive to the initial high intensity light or the emitted higher energy wavelength, respectively. For example, the first (e.g., high intensity) photoinitiator can include one or more sensitizer and triplet annihilators, while the second (e.g., higher energy) photoinitiator can include Norrish Type 1 photoinitiators with medium to strong absorbance (e.g., from 1 to 1,000 (very low), from 1,000 to 10,000 (low), from 10,000 to 30,000 (med), from 30,000 to 50,000 (strong), from 50,000 and greater (very strong) molar absorptivity units) at the higher energy upconverted photon. In some embodiments, the higher the extinction coefficient of the higher energy photoinitiator, the more localized the curing can remain to the emission source of the upconverted photon, thus increasing resolution. Similar hybrid systems can be combined to create similar high resolution VAM printing, such as photoactivated inhibitors, photoactivated blockers (e.g., photochromics), two-photon absorption, etc. Such hybrid approaches may be useful for curing the surfaces of objects where the difference in dosage for two neighboring voxels may be very similar and thus resolution may be detrimentally affected. With hybrid systems, the interior volume of the object may be cured by known VAM processes with the dose accumulation techniques described herein, while the surface or sections thereof that require higher resolution may use upconverted photon and other two photon techniques (e.g., sequential or simultaneous photon techniques).

In some embodiments, higher resolution can be obtained using two different wavelengths of light and photoinitiator systems, e.g., as in xolography. A xolography process can use photoswitchable photoinitiators to induce local polymerization inside a volume of photosensitive material upon linear excitation by intersecting light beams of different wavelengths. In some embodiments, two or more wavelengths of light are used to enable two different chemical reactions (e.g., free radical and cationic polymerizations, or other orthogonal chemistry reactions) which allow for spatial control of material properties (e.g., creation of interpenetrating polymer networks (IPNs), polymerization induced phase separations, and/or others).

Moreover, some of the components of the system 100 can be omitted. For example, although the illustrated embodiment depicts the curable material 102 as being contained within the reservoir 104, in embodiments where the curable material 102 is highly viscous and exhibits little or no flow after deposition, the reservoir 104 can be omitted, and the curable material 102 can be deposited directly onto the platform 106. Accordingly, any embodiments herein that are described in connection with the curable material 102 being within the reservoir 104 can be adapted to the curable material 102 being positioned directly on the platform 106.

In some embodiments, rather than using energy sources 108 to cure the curable material 102, an inverse process can be used in which the starting material is already in a partially or fully cured state, and the energy sources 108 selectively degrade, liquify, or otherwise reverse the curing of the cured material. Examples of materials that can be used for this approach include degradable polymers and degradable oligomers. For instance, the material can be or include a vitrimer. As another example, the material can be or include a polyacetal. In some embodiments, the energy causes a change in the cured material that allows selected portions of the cured material to liquify and be removed in post-processing (e.g., via solvent dissolution, melting, mechanical handling, sonication). Some non-limiting examples of chemistries that can be used to degrade a polymer and/or oligomer (e.g., including vitrimers) are depolymerization by heat (e.g., low ceiling temperature polymers), photodimer reversion, photocleaving of bonds, and/or activation of photoacids, bases, or other catalyst that then lead to breaking of bonds. Other techniques can alternatively or additional be used to separate a cured object from the remaining material, such a phase transition from a crystalline phase to an amorphous phase. For instance, heat can be selectively absorbed into sections of the curable material 102 that are not part of the object and, if the time to reform crystals is low or prevented upon melting (such as via forming a cutectic mixture), then the crystalline object can be separated from the amorphous uncured material.

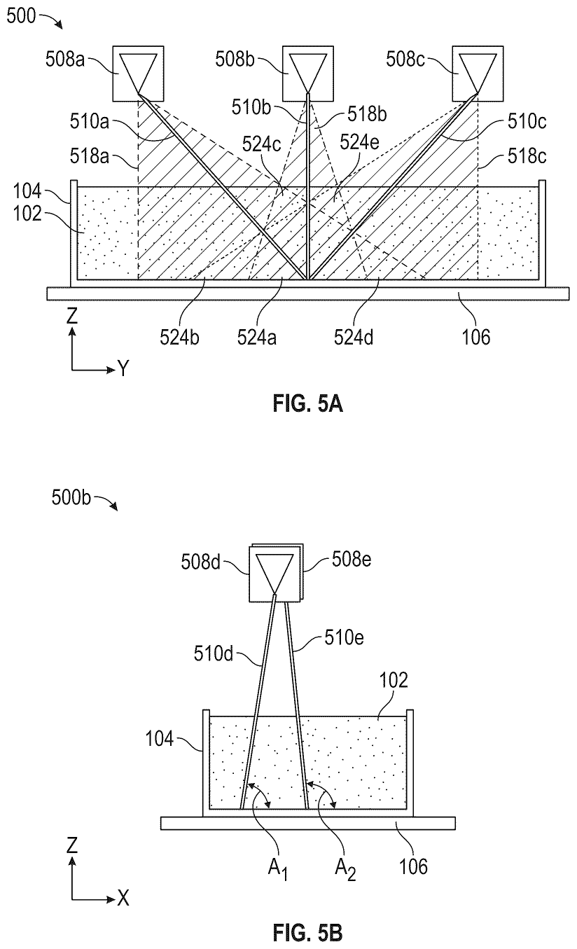

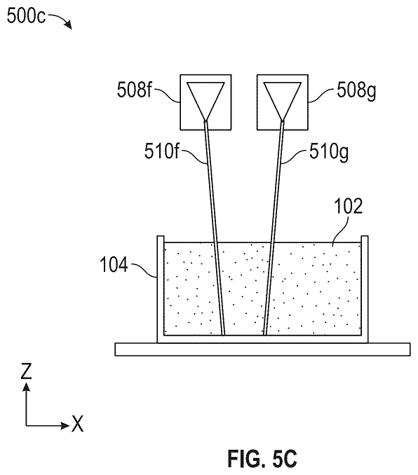

FIGS. 5A-9C illustrate various features of additive manufacturing systems configured in accordance with embodiments of the present technology. Any of the features of the embodiments of FIGS. 5A-9C can be combined with each other and/or incorporated into the system 100 of FIGS. 1A-4D. Moreover, the systems described in connection with FIGS. 5A-9C can be generally similar to the system 100 of FIGS. 1A-4D, such that like numbers (e.g., energy source 108 versus energy source 508) are used to identify similar to identical components, and the following discussion of FIGS. 5A-9C will be limited to those features that differ from the embodiment described in connection with FIGS. 1A-4D.

FIGS. 5A-5C illustrate additive manufacturing systems with various arrangements of energy sources, in accordance with embodiments of the present technology. For example, FIG. 5A is a partially schematic front cross-sectional view of an additive manufacturing system 500a including three energy sources 508a-508c (collectively, “energy sources 508”). Specifically, the system 500a includes a first energy source 508a configured to scan a first energy beam 510a through a first scanning region 518a, a second energy source 508b configured to scan a second energy beam 510b through a second scanning region 518b, and a third energy source 508c configured to scan a third energy beam 510c through a third scanning region 518c. The energy sources 508 can be any of the energy sources described herein, such as lasers, LEDs, broadband light sources, etc.

The energy sources 508 can be positioned above the reservoir 104 so as to direct their respective energy beams 510a-510c (collectively, “energy beams 510”) into the curable material 102. Some or all of the energy sources 508 can be at the same height (e.g., Z-position), or some or all of the energy sources 508 can be at different heights. In some embodiments, the energy sources 508 are arranged in an array lying within the same YZ-plane of the system 500a. The energy sources 508 can be distributed along the Y-axis of the system 500a.

The scanning regions 518a-518c (collectively, “scanning regions 518”) produced by the energy sources 508 can be 2D shapes that each lie within a respective plane. In the illustrated embodiment, for example, the scanning regions 518 are fan-shaped regions produced by sweeping the energy beams 510 through respective arcs. Some or all of the scanning regions 518 can lie within the same plane (e.g., the same YZ-plane), or some or all of the scanning regions 518 can lie within different planes (e.g., different YZ-planes), depending on the position and configuration of the energy sources 508. Moreover, some or all of the scanning regions 518 can have the same angular range, or some or all of the scanning regions 518 can have different angular ranges.

The scanning regions 518 can overlap each other at one or more overlap locations. For instance, as shown in FIG. 5A, the first, second, and third scanning regions 518a-518c can overlap each other at an overlap region 524a; the first and third scanning regions 518a, 518c can overlap each other at overlap regions 524b, 524c; the first and second scanning regions 518a, 518b can overlap each other at an overlap region 524c; and the second and third scanning regions 518b, 518c can overlap each other at an overlap region 524e. Some or all of the scanning regions 518 can also include a nonoverlap region that is not accessible by other energy sources 508.

As described herein, the curable material 102 can be solidified when the combined energy dosage applied to a particular location (e.g., voxel) in the curable material 102 is greater than or equal to a threshold dosage. The threshold dosage can be achieved by simultaneously or sequentially applying energy to the location within the curable material 102 using multiple energy sources 508. In some embodiments, the threshold dosage is achievable using at least two energy sources 508, such that an object portion can be formed in any of the overlap regions 524a-524c. Alternatively, the threshold dosage can be achieved using only when all three energy sources 508 are used, such that an object portion can be formed only in the overlap region 524a.

Although the systems of FIGS. 1A-4D and 5A are depicted as including two and three energy sources, respectively, the present technology can be adapted to include any suitable number of energy sources, such as four, five, six, seven, eight, nine, ten, or more energy sources. The energy sources can be arranged in any suitable configuration to produce scanning regions that intersect at one or more overlap regions within the curable material, thus allowing for selective solidification of the curable material within the overlap regions by simultaneously or sequentially delivering energy to selected locations using two or more energy beams. Any of the embodiments herein can be modified so that at least two, three, four, five, or more energy sources are needed to deliver the threshold energy dosage; and/or so that no more than five, four, three, or two energy sources are needed to deliver the threshold energy dosage. In some instances, a larger number of energy sources may provide a larger range of locations within the curable material that can be individually “addressed” with a specified energy dosage, and/or may provide more flexibility in that multiple different combinations of energy sources can be used to deliver energy to a particular location. In some embodiments, only one energy source is needed or used to provide energy for curing one or more voxels, such as when multiple reflective elements are used and/or where other technologies are combined with the present technology such as photon upconversion and/or photodegradation and/or when a given object has a portion that can be fully cured by just one energy source.

FIG. 5B is a partially schematic side view of an additive manufacturing system 500b with angled energy sources 508d, 508e in accordance with embodiments of the present technology. The system 500b includes a first energy source 508d that outputs a first energy beam 510d, and a second energy source 508c that outputs a second energy beam 510c. As shown in FIG. 5B, the energy beams 510d, 510e are angled so that the corresponding scanning regions of the energy beams 510d, 510e are also angled relative to the X-axis of the system 500b, rather than lying within the same YZ-plane. For example, the scanning region of the energy beam 510d can be at acute angle A₁ relative to the X-axis, e.g., the angle A₁ can be less than 90° and/or less than or equal to 80°, 70°, 60°, 50°, 40°, 30°, 20°, or 10°. The scanning region of the energy beam 510c can be at an obtuse angle A₂ relative to the X-axis, e.g., the angle A₂ can be greater than 90° and/or greater than or equal to 100°, 110°, 120°, 130°, 140°, 150°, 160°, or 170°. In the illustrated embodiment, the scanning regions of the energy sources 508d, 508e lie within different planes; in other embodiments, however, the energy sources 508d, 508e can be configured to output energy beams 510d, 510e at the same angle such that the scanning regions lie within the same plane.

The systems herein can be adapted to include any suitable number of energy sources, each of which can independently produce a scanning region that is at any suitable angle relative to the X-axis (e.g., an angle of 10°, 20°, 30°, 40°, 50°, 60°, 70°, 80°, 90°, 100°, 110°, 120°, 130°, 140°, 150°, 160°, or) 170°. Some or all of the scanning regions can be at the same angle, or some or all of the scanning regions can be at different angles. The use of scanning regions at different angles can provide a larger range of addressable locations within the curable material.

FIG. 5C is a partially schematic side view of an additive manufacturing system 500c with offset energy sources 508f, 508g in accordance with embodiments of the present technology. The system 500c includes a first energy source 508f that outputs a first energy beam 510f, and a second energy source 508g that outputs a second energy beam 510g. As shown in FIG. 5C, the energy sources 508f, 508g are at different positions along the X-axis of the system 500c. For instance, the energy sources 508f, 508g can be spaced apart by a distance within a range from 0.5 cm to 1 cm, 1 cm to 2 cm, 2 cm to 5 cm, 5 cm to 10 cm, or 10 cm to 20 cm. Accordingly, the scanning regions produced by the energy sources 508f, 508g can also be spaced apart and lie within different planes. Although FIG. 5C depicts the scanning regions as being at different angles relative to the X-axis, in other embodiments, the scanning regions can be at the same angle relative to the X-axis (which can be an orthogonal angle, an acute angle, or an obtuse angle, as described herein).

The systems herein can be adapted to include any suitable number of energy sources, some or all of which can be at the same position along the X-axis of the system, or some or all of which can be at different positions along the X-axis of the system. Moreover, some or all of the energy sources can be at the same position along the Y-axis of the system, or some or all of the energy sources can be at different positions along the Y-axis of the system. For example, the system can include an array of energy sources that lie within an X-Y plane of the system, such as a square array, rectangular array, circular array, or any other suitable array shape. Additionally, some or all of the energy sources can be at the same position along the Z-axis of the system, or some or all of the energy sources can be at different positions along the Z-axis of the system. In general, the systems herein can include any suitable spatial arrangement of energy sources relative to the curable material.

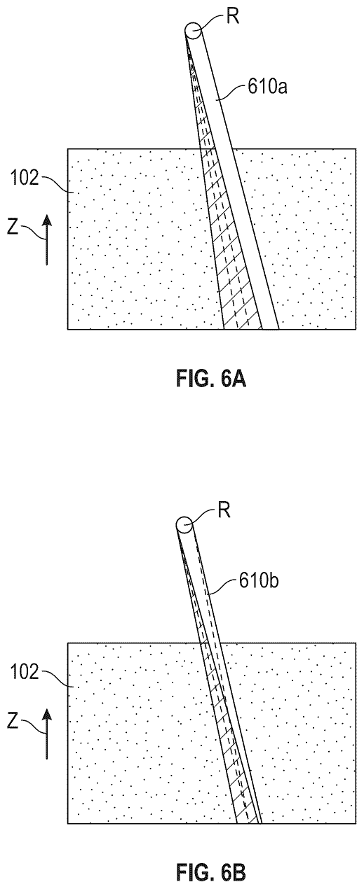

FIGS. 6A and 6B illustrate different beam shapes that can be produced by an energy source of an additive manufacturing system, in accordance with embodiments of the present technology. For instance, FIG. 6A is a partially schematic diagram of an energy beam 610a having a constant diameter along its length (e.g., the energy beam 610a can be a collimated light beam). In some embodiments, for a given amount of rotation about an axis of rotation R, the area swept by the energy beam 610a increases with increasing distance from the axis of rotation R, thus producing a fan-shaped scanning region. Accordingly, in embodiments where the axis of rotation R is positioned above the curable material 102, voxels that are at a higher Z-position may be larger than voxels that are at a lower Z-position). Stated differently, the energy dosage delivered by the energy beam 610a may be spread out over a larger volume at deeper locations within the curable material 102. This effect can be further increased when using energy beams that have a diverging diameter in which the beam size increases with distance from the axis of rotation R.

In some embodiments, the software algorithm accounts for the different energy dosages delivered to voxels at different Z-positions within the curable material 102 when determining the appropriate scanning parameters. Alternatively or in combination, the difference in energy dosage can be reduced by positioning the axis of rotation further from the surface of the curable material 102. In such embodiments, it may be advantageous to use multiple other energy sources that are spaced further apart from each other to decrease the voxel size and/or to improve the ability to irradiate a given voxel independent from neighboring voxels via overlapping scanning regions.

FIG. 6B is a partially schematic diagram of an energy beam 610b having a converging diameter in which the beam size decreases with distance from the axis of rotation R. In some embodiments, the converging shape of the energy beam 610b causes the intensity to increase with increasing distance from the axis of rotation R, but this increase in intensity can be balanced out by the increase in swept area. Accordingly, the energy beam 610b can deliver the same or substantially the same energy dosage to different Z-positions within the curable material 102.

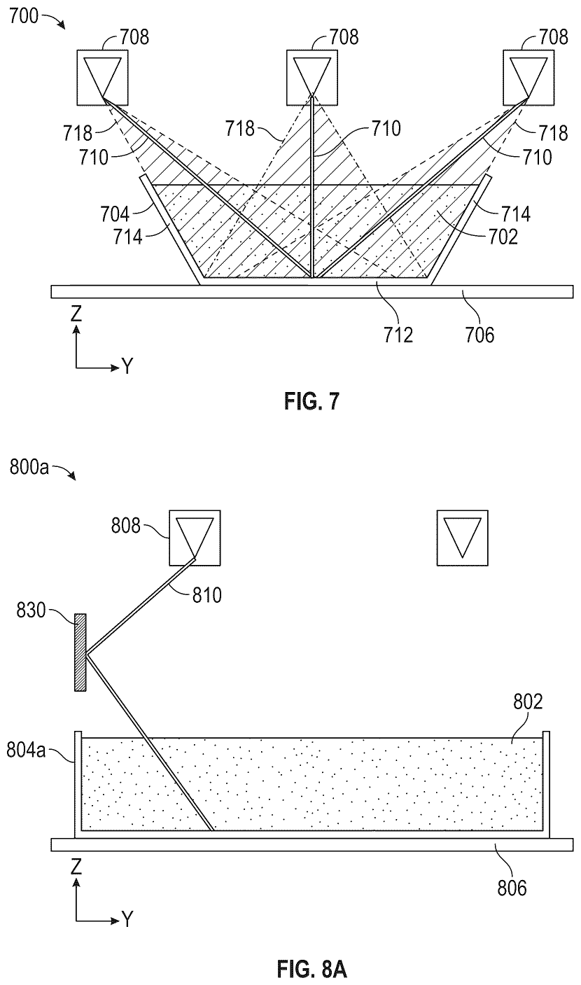

FIG. 7 is a partially schematic front cross-sectional view of an additive manufacturing system 700 configured in accordance with embodiments of the present technology. The system 700 includes a curable material 702 within a reservoir 704 on a platform 706, and a plurality of energy sources 708 that output respective energy beams 710.

The reservoir 704 includes a bottom wall 712 and a plurality of sidewalls 714. As shown in FIG. 7, the sidewalls 714 are angled outwards to conform to the shape of the scanning regions 718 produced by the energy sources 708, e.g., the inner surfaces of the sidewalls 714 can be aligned with the outer boundaries of the scanning regions 718. For instance, the angle between the bottom wall 712 and each sidewall 714 can be at least 90°, 100°, 110°, 120°, 130°, 140°, 150°, 160°, or 170°. Accordingly, the reservoir 704 can have a trapezoidal cross-sectional shape, with the upper portion of the reservoir 704 being wider than the lower portion of the reservoir 704. This configuration can be advantageous for reducing the volume of curable material 702 used by the system 700, since curable material 702 lying outside the scanning regions 718 may not be accessible by the energy sources 708 and thus may be unavailable for forming the object.

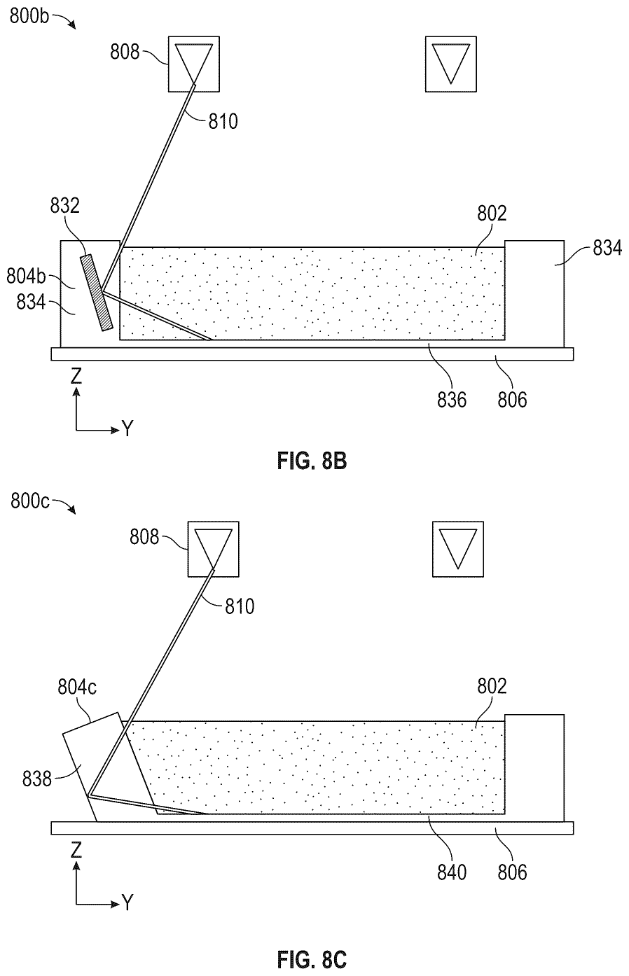

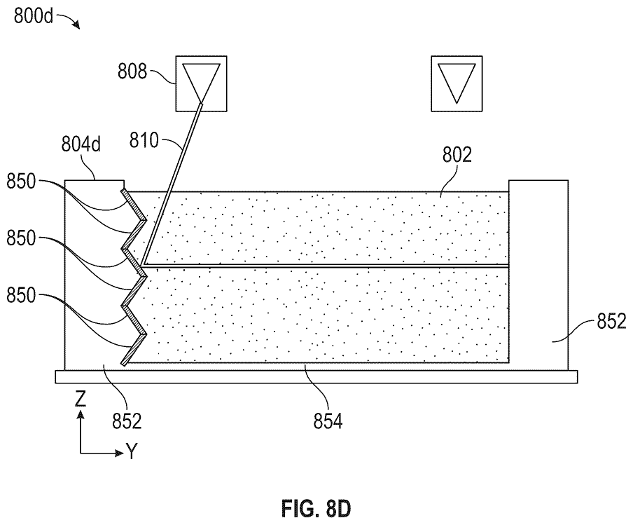

FIGS. 8A-8C illustrate additive manufacturing systems with optical elements for redirecting energy, in accordance with embodiments of the present technology. The optical elements can be reflective elements, refractive elements, or suitable combinations thereof. The use of optical elements to redirect an energy beam can be used to increase the range of locations within the curable material that can be accessed by the energy beam. In some embodiments, the optical element effectively creates a new “energy source” by redirecting the energy beam, such that a fewer number of energy sources can be used, or even a single energy source.

For example, FIG. 8A is a partially schematic front cross-sectional view of an additive manufacturing system 800a including a reflective element 830 (e.g., a mirror) for deflecting an energy beam 810 produced by an energy source 808. The reflective element 830 can have a fixed position and orientation, or the reflective element 830 can be adjustable (e.g., translated and/or rotated) to control the direction of the deflected energy beam 810. In the illustrated embodiment, the reflective element 830 is a separate component that is spaced apart from the reservoir 804a. For instance, the reflective element 830 can be positioned above and to one side of the reservoir 804a. In other embodiments, however, the reflective element 830 can be positioned at a different location in the system 800a, such over the central portion of the reservoir 804a. In still other embodiments, the reflective element 830 can be attached to and/or part of the reservoir 804a (e.g., above the level of the curable material 802). Alternatively, the reflective element 830 can be below the reservoir 804a and/or the platform 806. Moreover, although FIG. 8A illustrates a single reflective element 830, the system 800a can alternatively include additional reflective elements 830, such as two, three, four, five, or more reflective elements 830.

FIG. 8B is a partially schematic front cross-sectional view of an additive manufacturing system 800b including a reservoir 804b with a reflective element 832 (e.g., a mirror) for deflecting an energy beam 810 produced by an energy source 808. The reflective element 832 can have a fixed position and orientation, or the reflective element 832 can be adjustable (e.g., translated and/or rotated) to control the direction of the deflected energy beam 810. In the illustrated embodiment, the reflective element 832 is embedded within a sidewall 834 of the reservoir 804b. Alternatively, the reflective element 832 can be positioned at another portion of the reservoir 804b, such as on a surface of a sidewall 834 of the reservoir 804b, within the bottom wall 836 of the reservoir 804b, or on a surface of the bottom wall 836 of the reservoir 804b. The portion of the reservoir 804b containing the reflective element 832 can be optically transparent to the energy beam 810 and/or can be matched to the refractive index of the curable material 802 to reduce refraction. Optionally, other portions of the reservoir 804b or even the entire reservoir 804b can be optically transparent and/or index matched to the curable material 802. Moreover, although FIG. 8B illustrates a single reflective element 832, the reservoir 804b can alternatively include additional reflective elements 832, such as two, three, four, five, or more reflective elements 832.

FIG. 8C is a partially schematic front cross-sectional view of an additive manufacturing system 800c in which the reservoir 804c acts as a reflective element for deflecting an energy beam 810 produced by an energy source 808. In the illustrated embodiment, the reservoir 804c includes a sidewall 838 that redirects the energy beam 810 via total internal reflection. For instance, the surface of the sidewall 838 that receives the incoming energy beam 810 can be made of, coated with, or otherwise include a material that produces total internal reflection of the energy beam 810. In other embodiments, other portions of the reservoir 804c can alternatively or additionally be configured as reflective elements, such as the bottom wall 840 of the reservoir 804c. The portions of the reservoir 804c that receive the incoming and/or deflected energy beam 810 can be optically transparent to the energy beam 810 and/or index matched to the curable material 802 to reduce refraction. Optionally, other portions of the reservoir 804b can be optically transparent and/or index matched to the curable material 802.

FIG. 8D is a partially schematic front cross-sectional view of an additive manufacturing system 800d including a reservoir 804d with an array of reflective elements 850 (e.g., mirrors) for deflecting an energy beam 810 produced by an energy source 808. The reflective elements 850 can be arranged in a 2D array (e.g., a grid) composed of a plurality of rows and a plurality of columns. Although six reflective elements 850 are visible in FIG. 8D, the system 800d can include any suitable number of reflective elements 850, such as 10, 15, 20, 25, 30, 40, 50, or more reflective elements 850. Some or all of the reflective elements 850 can have a fixed position and orientation, or some or all of the reflective elements 850 can be adjustable (e.g., translated and/or rotated) to control the direction of the deflected energy beam 810. In the illustrated embodiment, the reflective elements 850 are configured as an array formed on a surface of a sidewall 852 of the reservoir 804d. Alternatively or in combination, the system 800d can include reflective elements 850 at other portions of the reservoir 804d, such as within the sidewall 852, on a bottom wall 854 of the reservoir 804d, or within a surface of the bottom wall 854 of the reservoir 804d. Optionally, the reflective elements 850 can be present on or within both sidewalls 852 of the reservoir 804d, and/or on or within the bottom wall 854 of the reservoir 804d.

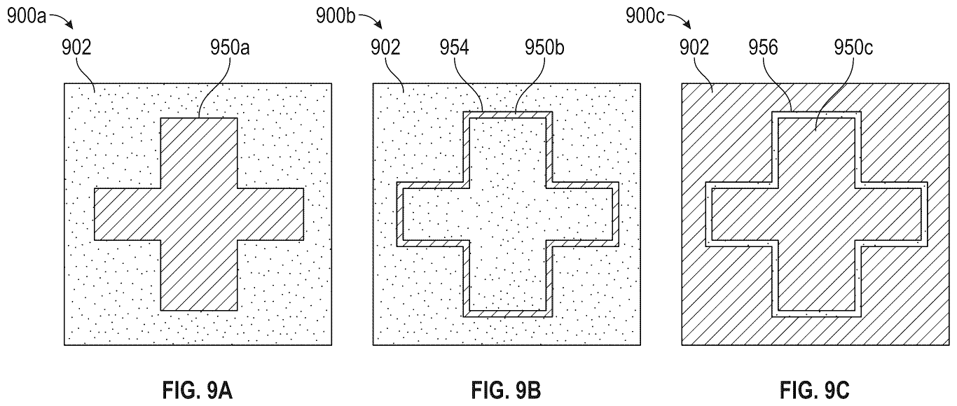

FIGS. 9A-9C illustrate various curing patterns that can be used to form an additively manufactured object, in accordance with embodiments of the present technology. For example, FIG. 9A is a cross-sectional view of a curing pattern 900a in which all of the curable material 902 within the object 950a has been solidified (e.g., has been cured past the gel point of the curable material 902), while all of the curable material 902 outside of the object 950a remains unsolidified (e.g., has not been cured past the gel point of the curable material 902). In some embodiments, curable material 902 that is adjacent to the surfaces of the object 950a may be more cured than the curable material 902 further away from the object 950a, but may still be below the gel point of the curable material 902.

FIG. 9B is a cross-sectional view of a curing pattern 900b in which a shell 954 corresponding to the surfaces of the object 950b is solidified, but the curable material 902 within the interior of the object 950b remains unsolidified. The curable material 902 outside the object 950b can also remain unsolidified. Optionally, the curable material 902 within the interior of the object 950b can be solidified in a separate curing process, such as curing using a different chemical reaction and/or post-curing after the additive manufacturing process.

FIG. 9C is a cross-sectional view of a curing pattern 900c in which some of the curable material 902 outside of the object 950c is solidified, but a shell 956 of curable material 902 surrounding the surfaces of the object 950c remains unsolidified. The object 950c can be solidified entirely as shown in FIG. 9C, or only the surfaces of the object 950c can be solidified (e.g., similar to the object 950b of FIG. 9B).

The additive manufacturing systems disclosed herein can be controlled using a set of fabrication instructions that specify how the various system components (e.g., energy sources, platform) should be operated to produce a desired object geometry. The fabrication instructions can be generated using a software algorithm. The input data to the software algorithm can include a digital representation of the geometry of the object, such as a 3D digital model (e.g., a surface model, mesh model, parametric model, etc.). Optionally, the input data can include system parameters indicating the particular configuration of the system, such as the locations of the energy sources, the characteristics of the energy sources (e.g., beam shape, beam size, wavelength, intensity, sweep rate, angular range, on/off rate), the size and shape of the reservoir, the movement speed of the reservoir, the movement direction of the reservoir, the layer thickness of the curable material, the type of curable material, the characteristics of the curable material (e.g., the threshold dosage for solidifying the curable material, penetration into and/or adsorption of the energy by the curable material), and/or the locations and characteristics of any reflective elements that are present (e.g., size, position, orientation, whether the reflective element is fixed or adjustable). The input data can be retrieved from a database, manually input by a human operator, determined from simulations and/or experimental data, obtained from one or more sensors, machine vision, or suitable combinations thereof. The output data of the software algorithm can be a digital data set indicating the scanning parameters of the energy sources (and, optionally, the movement of the reservoir and/or orientation of adjustable light reflectors) to produce the object geometry.

The software algorithm can be implemented in many different ways. For example, the software algorithm can determine, for each voxel within the curable material, an appropriate energy dosage (e.g., energy intensity and exposure time) to be delivered to the voxel to either solidify or avoid solidification of the curable material at that voxel. The software algorithm can then determine how each energy source should be controlled to deliver the appropriate dosage to each location. For instance, the software algorithm can determine a set of scanning parameters for each energy source to produce the energy dosage at that voxel. In some embodiments, the set of scanning parameters includes, for each sweep of each energy beam through its respective scanning region at a particular X-position within the curable material, the timing with which the energy beam should be turned on and off during the sweep (“activation pattern”) to deliver the appropriate energy dosage to each voxel within the scanning region.

In some embodiments, the voxel size used by the software algorithm is defined based on the beam diameter (e.g., X- and/or Y-dimension) and/or the overlap of beam diameters from each energy source (e.g., no overlap in each voxel occurs during each X-dimensional translation of the reservoir). The beam diameter can be defined as the full width at half maximum intensity of the beam, e.g., for a circular Gaussian beam. Optionally, the cure dynamics of the curable material can also be considered in determining the voxel size, such as the diffusion rate of reactive and/or inhibitory species, reactive diffusion, Trommsdorff-Norrish effects, exothermic and/or endothermic effects on the rate of reaction, photoinitiator bleaching, light absorbance from initiator and/or other components, etc.

Additionally, the translation of the reservoir in the X-dimension (“X-translation”) does not need to be in full units of the beam width, but rather can be in fractional units of the beam width (e.g., 1/10 of the beam diameter or half of the beam diameter). In some embodiments, the X-translation is continuous, rather than in discrete units. In such embodiments, the scan time can be faster than the X-translation, such that a full sweep of an X-dimensional segment through the curable material can occur before a significant movement of the reservoir in the X-direction has occurred. For example, if the reservoir translates in the X-direction at a rate of 1 mm/s, the sweep rate is such that a full sweep of the energy beam through the YZ-plane takes 0.001 seconds, and the beam diameter is 0.10 mm, then the X-translation during the exposure is 0.001 mm, which is 1% of the beam diameter. Thus, 5 full sweeps can occur before a 5% change in the beam diameter, which may be sufficiently small so as to still count as a single unit of beam diameter, if an X-based unit approach to the voxels is used. Depending on the desired X-dimensional resolution, larger or smaller translational drifts in the X-direction can occur for a given voxel, such as less than 1%, 2%, or 10%, and/or up to 100%. In some embodiments, translational drifts of less than 10%, 5%, 2%, 1%, 0.1%, or 0.01% are used.

In some embodiments, the sweep rate for some or all of the energy sources is the same rate as the movement rate (e.g., X-translation rate) of the reservoir. Alternatively, the sweep rate can be at least 2×, 5×, 10×, 100×, or 1000× the movement rate. The sweep rate of the energy source can be independent of the on/off rate of the energy source, such that during a given sweep through the scanning region, the energy source can be turned on and off to create individual arcs of energy. The smallest useful arc may be one that can create a voxel of 1 beam diameter at the deepest section of the layer of curable material. Accordingly, the energy source can be configured to turn on and off at rates faster than the sweep rate. Thus, the voxel size in the YZ-plane can be controlled by the sweep rate and the on/off rate of the energy source.

The software algorithm can also take into account the dosage provided to one or more voxels adjacent to the target voxel, and can determine whether any curing or solidification of the adjacent voxels would occur. In some embodiments, the threshold dosage for solidification is reduced for voxels adjacent to a solidified voxel, since Trommsdorff-Norrish effects, reduced inhibitor concentrations, and/or the increased viscosity at the voxel can decrease termination rates and/or increase the overall polymerization rate. In embodiments where the curable material includes multiple different resins, the software algorithm can account for the individual characteristics (e.g., dosage requirements) for each resin.

In some embodiments, the software algorithm determines an energy dosage to produce curing of the curable material well beyond the gel point in a controlled manner. In conventional VAM systems, the object is generally cured right up to the gel point, which may leave the object with a low green strength and can make it difficult to handle and/or clean the object. Often the object can be damaged during removal from the curable material (e.g., particularly for viscous resins), or can be damaged when solvents or mechanical techniques are used to clean the green state object. Curing of the object well above the gel point can increase the green strength of the object. In some embodiments, the software algorithm is configured to create a significantly cured region within and/or at the surface of the object. The region can be a grid, scaffold, shell, and/or solid region. In some embodiments, the algorithm maximizes curing at the surface and/or the interior of the object, while maximizing undercuring for the voxels adjacent to the surface of the object. Optionally, the algorithm can ignore regions that are at least one, two, three, or more voxels away from the surface of the object, e.g., by implementing customized loss functions in the optimization.

In some embodiments, the software algorithm creates a gradient of energy dosages within the curable material, which can be used to create spatial variations in one or more properties of the cured material such as modulus, transparency, color, impact resistance, elongation to yield, elongation to break, solubility in a solvent, density, melting point, percent crystallinity, etc. This approach, also known as “grayscaling,” can use the applied energy dosage to directly cause a specific property outcome for the material. Grayscaling can be used to spatially define regions within an additively manufactured object that have specific material properties dependent solely on the energy dosage received during the additive manufacturing process, or the material properties can be primarily dependent on the energy dosage received during the additive manufacturing process and have further dependencies such as various post-processing factors (e.g., time, solvent cleaning, heating, light exposures, addition of wet chemistry modifications). Additional examples and details of grayscaling techniques that can be incorporated into the present technology are provided in U.S. patent application Ser. No. 18/449,589, the disclosure of which is incorporated by reference herein in its entirety.

Moreover, in contrast to conventional VAM algorithms that only consider two potential curing levels (e.g., solidified versus unsolidified) when determining energy dosage, which may result in weak printed objects, the software algorithm disclosed herein can consider three or more different curing levels for optimization of energy dosages. Curing level may be quantified in terms of a percent of cure relative to the percent of cure at the gel point of the material and the maximum possible percent of cure for the material, e.g., curing level=(% cure−% cure at gel point)/(maximum possible % cure−% cure at gel point)×100%. Accordingly, amounts of “overcuring” can be defined, e.g., from 0% overcuring (cure level equals the % cure to achieve gelation) to 100% (cure level is the maximum possible % cure). As such, curing levels such as 5%, 10%, 20%, or more overcuring can be used for selected voxels and/or regions when optimizing the energy dosage. Alternatively or in combination, curing level may be quantified in terms of the green strength of the cured material relative to the green strength of the material when cured to the gel point, such that “overcuring” occurs when the green strength of the cured material exceeds the green strength of the material at gel point (e.g., is 20%, 50%, 100%, 200% or 1000% greater than the green strength at gel point), as measured using dynamic mechanical analysis, tensile testing, rheological testing, etc. For instance, the structural “backbone” of the object may be chosen to have a higher curing level (e.g., be near 100% overcuring) to provide high strength to allow for physical handling of the printed part during post-processing, while other portions of the object may have lower curing levels.

In some embodiments, the software algorithm defines regions of importance for the object. In some instances, a printed object does not need to be 100% accurate at all portions; instead there may be certain portions that require high accuracy and other portions where lower accuracy is acceptable. For example, in embodiments where the object is a dental appliance having a shell with a plurality of cavities to receive and reposition teeth, the interior surfaces of the cavities may require a higher degree of accuracy, while the exterior surfaces of the shell can be less accurate. Accordingly, the interior surfaces may be fabricated with the full resolution of the system, whereas the exterior surfaces may be fabricated with a lower resolution. The resolution may be defined in terms of a range of voxels that reach the gel point at a surface of interest the object, e.g., a high-resolution region is within +/−1 voxels of the designed surface geometry, whereas a low-resolution region can be within +/−2 voxels, +/−3 voxels, +/−4 voxels, +/−5 voxels, etc. Optionally, upper and lower limits can be set, e.g., the object may be greater than 5 voxels overcured from outside of the surface of the object, but less than 2 voxels undercured (e.g., the material has not reached the gel point) inside of the surface of the object. Thus, the software algorithm can optimize printing accuracy for the portions of the object that need it, and therefore can arrive at a solution faster than if the algorithm were to optimize the entire object for the highest level of accuracy.

Representative examples of parameters that can be considered and/or used by the software algorithm disclosed herein include: beam shape, sweep rate, dwell time at each angle, energy intensity, energy wavelength(s), on/off switching rate, time for the energy source to be completely on, time for the energy source to be completely off, time to change the direction of the energy beam, time to change the sweep rate of the energy beam, movement speed of the reservoir, movement direction of the reservoir, angle of energy (e.g., light) incidence on the curable material, reactivity of the curable material, temperature of the curable material, energy absorption characteristics of the curable material, viscosity of the curable material, concentration of chemical species in the curable material (e.g., monomers and other reactive species, inhibitors, photoinitiators and other catalysts, photoblockers), diffusion rate of chemical species in the curable material, and locations and orientations of reflective elements. Other information that can be used to improve the quality and accuracy of the printed object include the desired cure extent of given voxels (e.g., grayscaling), the dosage received by neighboring voxels, location of voxels next to interfaces (e.g., liners, reservoir, air, walls, inserted components), time delay between energy doses, scattering in the curable material, shadow regions created by other components in the curable material, and refraction/reflection caused by other components in the curable material.

In some embodiments, the software algorithm only uses one or more of the following parameters to determine the appropriate dosage for each voxel: beam shape, sweep rate, dwell time, energy intensity, energy wavelength, on/off switching rate, time for the energy source to be completely on, time for the energy source to be completely off, time to change the direction of the energy beam, time to change the sweep rate of the energy beam, reactivity of the curable material, temperature of the curable material, energy absorption characteristics of the curable material, viscosity of the curable material and/or locations and orientations of reflective elements.

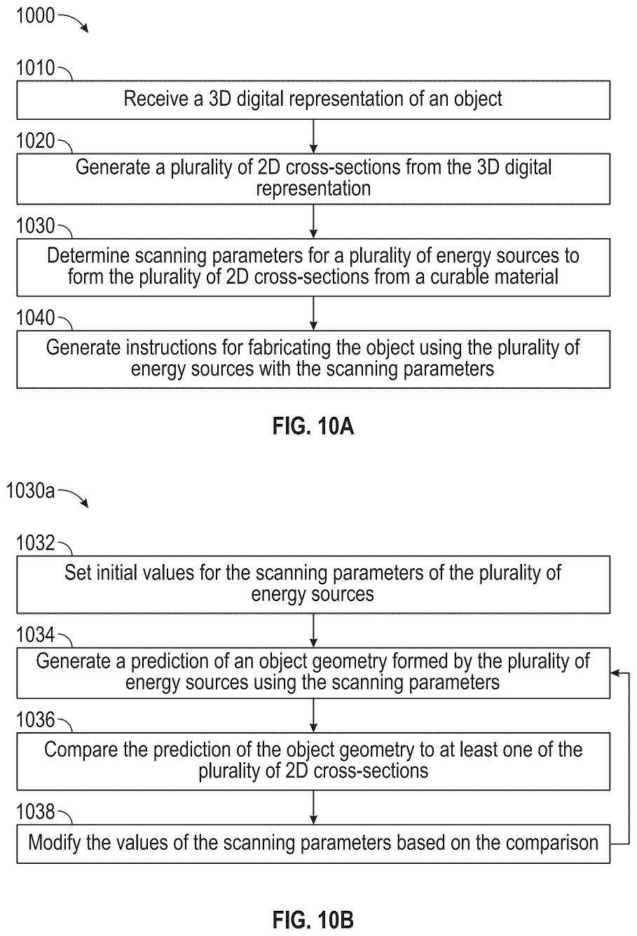

FIG. 10A is a flow diagram illustrating a method 1000 for determining scanning parameters for fabricating an additively manufactured object, in accordance with embodiments of the present technology. The method 1000 can be used to produce fabrication instructions for any of the systems and devices described herein, such as any of the embodiments of FIGS. 1A-9C. In some embodiments, some or all of the processes of the method 1000 are implemented as computer-readable instructions (e.g., program code) that are configured to be executed by one or more processors of a computing device.

The method 1000 can begin at block 1010 with receiving a 3D digital representation of an object to be fabricated. The 3D digital representation can be any digital data set representing the geometry of the object, such as a 3D digital model (e.g., a surface model, mesh model, parametric model, etc.).

At block 1020, the method 1000 can continue with generating a plurality of 2D cross-sections from the 3D digital representation. The 2D cross-sections can correspond to a plurality of portions of the object (e.g., slices and/or layers of the object) to be formed using an additive manufacturing system with scanned energy sources, as disclosed herein. For example, the 2D cross-sections can be a plurality of YZ-planes of the object taken at successive locations along the X-axis of the object, with each YZ-plane corresponding to a single sweep of the energy sources through their respective scanning regions in the YZ-plane of the system. Optionally, the process of block 1020 can also include discretizing the object geometry into a plurality of voxels. The voxel size may correspond to the minimum resolution of the additive manufacturing system, and may be determined based on the beam diameters of the energy sources, overlap of beam diameters of the energy sources, sweep rate of the energy sources, translation rate of the reservoir, and/or translational drift, as discussed above.

At block 1030, the method 1000 can include determining scanning parameters for a plurality of energy sources to form the plurality of 2D cross-sections from a curable material. The plurality of energy sources can be configured according to any of the embodiments described herein (e.g., in connection with FIGS. 1A-9C). For example, the energy sources can be configured to output a plurality of respective energy beams that are scanned through a plurality of respective scanning regions in the curable material, with the scanning regions overlapping each other at one or more locations to allow the energy beams to simultaneously or sequentially deliver energy to those locations. In some embodiments, the energy sources are light sources (e.g., lasers, LEDs) that produce light beams (e.g., laser beams) that are swept through the curable material. The curable material can be a resin including one or more polymerizable components that solidify upon exposure to a threshold energy dosage. The curable material can be contained within a reservoir that is advanced relative to the energy sources as the energy sources are scanned through the curable material. Optionally, one or more reflective elements can be positioned on, within, and/or proximate to the reservoir to deflect the energy beams.

The scanning parameters can be configured so that the curable material is selectively solidified at one or more object locations of the 2D cross-sections, and is not solidified at one or more locations that are not part of the 2D cross-sections. Specifically, the scanning parameters can be configured to cause the energy sources to deliver a combined energy dosage to the object locations that exceeds the threshold dosage for solidification, while the combined energy dosage delivered to other locations does not exceed the threshold dosage. The scanning parameters can be or include any adjustable parameter of the additive manufacturing system that influences the characteristics and/or spatial distribution of the energy produced by one or more energy sources. For example, the scanning parameters can include any of the following: energy intensities of one or more energy sources (e.g., energy intensity over time, energy intensity at each angle of the energy beam of the energy source), activation patterns of one or more energy sources, sweep rates of one or more energy sources, dwell time of one or more energy sources at each angle, beam shapes of one or more energy sources, locations of one or more energy sources, and/or locations and orientations of one or more reflective elements (if present).

In some embodiments, the scanning parameters are determined using a software model that predicts, for a particular set of scanning parameters, the energy dosages that would be delivered to each location in the curable material—and thus, the corresponding object geometry that would be formed. The predictions produced by the software model can be used in an optimization procedure to determine a set of scanning parameters to produce a distribution of energy dosages that achieves the desired object geometry. For example, in embodiments where the energy is light energy, the model can be a light field prediction model that calculates the global light dosage distribution to the curable material, thereby predicting the locations where the curable material will and will not be solidified by the light energy. The light field prediction model can be used as part of an optimization procedure to calculate the scanning parameters for the light sources that achieve the desired global light dose distribution to form the 2D cross-sections of the object with a sufficient degree of accuracy. In some embodiments, the light field prediction model is used to optimize one or more of the following: light intensity produced by each light source at each point in time and/or at each angle of the light beam, dwell time of the light beam at each angle, light beam scanning velocity through time, light beam shape, number of light sources used, positions of the light sources, and/or orientations and positions of reflective elements (if any).

For example, FIG. 10B illustrates a method 1030a for determining scanning parameters using a prediction model, in accordance with embodiments of the present technology. The method 1030a may be performed as part of the process of block 1030 of FIG. 10A, in accordance with embodiments of the present technology.

The method 1030a can begin at block 1032 with setting initial values for the scanning parameters of the energy sources. The initial values can be randomized values, preset values, values provided by a user, or suitable combinations thereof. In some embodiments, the initial values are estimates of the optimal values for the scanning parameters. The estimates may be based on scanning parameters used for other objects with similar geometries, experimental data, user input, etc.

At block 1034, the method 1030a can include generating a prediction of an object geometry formed from the plurality of energy sources using the scanning parameters. The prediction can be generated using a software model that determines the energy dosages delivered to each location in the curable material, based on the initial values of the scanning parameters. The energy dosages can then be used to evaluate whether the curable material will be solidified or will remain unsolidified at each location, (e.g., by comparing the energy dosage to the threshold dosage), thereby predicting the object geometry that will be formed.

The model can use any suitable technique to generate the prediction, such as simulations (e.g., ray tracing-based approaches), mathematical calculations (e.g., analytical expressions), machine learning algorithms, rule-based algorithms, or suitable combinations thereof. For example, a ray tracing-based approach can involve generating a plurality of rays representing the energy beams produced by the energy sources, determining the travel path of each ray through the curable material, then calculating the energy dosage delivered to each voxel of the curable material based on the travel paths of all the rays. Each energy source can be represented by a respective set of rays at different angles, e.g., corresponding to the angles swept by the energy beam output by the energy source. Each ray can be associated with an intensity value, e.g., corresponding to the energy intensity and/or activation pattern of the energy beam for each angle as determined by the scanning parameters. The number of rays used in the calculation can be selected to provide sufficiently high accuracy while also maintaining computational efficiency. For instance, the scanning region of an energy source can be represented by at least 20, 50, 100, 200, 500, or 1000 rays. The ray-based approach may be advantageous for modeling systems with more complex geometries and/or movable components.

Optionally, the energy dosage calculation can also consider the interactions of the rays with the curable material and/or other components, such as reflection of the rays off the walls of the reservoir and/or any reflective elements that are present, as well as absorption of the rays by the curable material. Other effects and/or material characteristics that may be considered in the calculation include diffraction, refraction, viscosity, thermal build-up, reactivity, diffusion, Trommsdorff-Norrish effects, exothermic and/or endothermic effects, and bleaching. In some embodiments, the effects of the rays can be calculated based on the total accumulated effects on a particular voxel (e.g., when curing is based on total accumulated energy dosage), based on instantaneous effects on a particular voxel (e.g., when curing is based on instantaneous energy intensity at each time, such as for upconversion), or suitable combinations thereof. Representative examples of energy dosage predictions generated using a ray tracing-based approach are provided in Example 1 below.

As another example, a mathematical approach can involve deriving an analytical expression for the energy dosage within the curable material. The analytical expression can then be evaluated at each voxel to calculate the energy dosage at that voxel for a given set of scanning parameters. For example, if the positions of an energy source, a voxel of curable material, and a flat reflective element are fixed, the angle at which an energy beam emitted from the energy source is reflected off the reflective element to the location of the voxel can be derived from geometric principles and the positions of each component. Accordingly, a geometric function can be used to determine which energy beams will reach each voxel, which in turn can be used to calculate the dosage delivered to each voxel. In some instances, evaluation of an analytical expression may be faster than other techniques and can allow for calculations at arbitrary locations throughout the computational domain.

Optionally, the prediction can be based on one or more system parameters of the additive manufacturing system. The system parameters can specify the characteristics of the various components of the additive manufacturing system, such as the configuration of the energy sources (e.g., locations, beam shape, sweep rate, on/off switching rate, time to be completely on/off, time to change direction, time to change sweep rate), configuration of the reservoir (e.g., size, shape, movement speed, movement direction), characteristics of the curable material (e.g., reactivity, temperature, energy absorption characteristics, viscosity), and/or configuration of any reflective elements that may be present (e.g., locations, sizes, shapes, adjustability). The system parameters may be differentiated from the scanning parameters in that the system parameters can represent fixed characteristics of the additive manufacturing system that cannot be changed, while the scanning parameters can represent adjustable characteristics of the additive manufacturing system that can be optimized. In some embodiments, for example, the prediction can assume that the locations, sweep rate, and beam shapes of the energy sources are fixed, but that the energy intensities and activation patterns of the energy sources are adjustable. Alternatively, the prediction can assume that the locations, sweep rate, and/or beam shapes are also adjustable. Optionally, if reflective elements are used, the locations and orientations of the reflective elements may be either fixed or adjustable, depending on the configuration of the additive manufacturing system.

At block 1036, the method 1030a can continue with comparing the prediction of the object geometry to at least one of the plurality of 2D cross-sections of the object. The 2D cross-sections can represent the target geometry for the object, while the predicted object geometry can be an estimate or simulation of the actual geometry that would be formed using the scanning parameters. The comparison can involve evaluating the similarity between some or all of the 2D cross-sections and the predicted geometry for one or more object portions (e.g., one or more slices and/or layers of the object), such as by calculating an error (e.g., distance-based error) between each 2D cross-section and the predicted geometry of the corresponding object portion.

At block 1038, the method 1030a can optionally include modifying the values of the scanning parameters, based on the comparison. For example, if the comparison indicates that the predicted object geometry is not sufficiently similar to the 2D cross-sections (e.g., the error exceeds a threshold value), one or more of the scanning parameters can be modified to increase the similarity (e.g., by reducing the error). The method 1030a can then return to block 1034 to generate an updated prediction of the object geometry using the modified values of the scanning parameters, and then to block 1036 to compare the updated prediction to the 2D cross-sections. The processes of blocks 1034, 1036, and 1038 can be repeated until values for the scanning parameters that provide a sufficient degree of similarity between the predicted and target object geometry are obtained (e.g., values that result in reduced or minimal error). In some embodiments, the processes of blocks 1034, 1036, and 1038 are performed as part of an optimization procedure, and the modifications to the scanning parameters are determined using optimization approaches known to those of skill in the art (e.g., gradient descent).

Referring again to FIG. 10A, after the scanning parameters are determined, the method 1000 can proceed to block 1040 with generating instructions for fabricating the object using the plurality of energy sources with the scanning parameters. For instance, the instructions can control the operation of the additive manufacturing system to cause the energy sources to scan their respective energy beams through the curable material according to the determined scanning parameters.

The methods illustrated in FIGS. 10A and 10B can be modified in many different ways. For example, although the above methods of FIGS. 10A and 10B are described with respect to a single object, these processes can be used to determine scanning parameters fabricating any suitable number of objects, such as tens, hundreds, or thousands of objects. As another example, the ordering of the processes shown in FIGS. 10A and 10B can be varied. Some of the processes of the methods can be omitted (e.g., the processes of blocks 1020 and/or 1040 of FIG. 10A) and/or the methods can include additional processes not shown in FIGS. 10A and 10B.

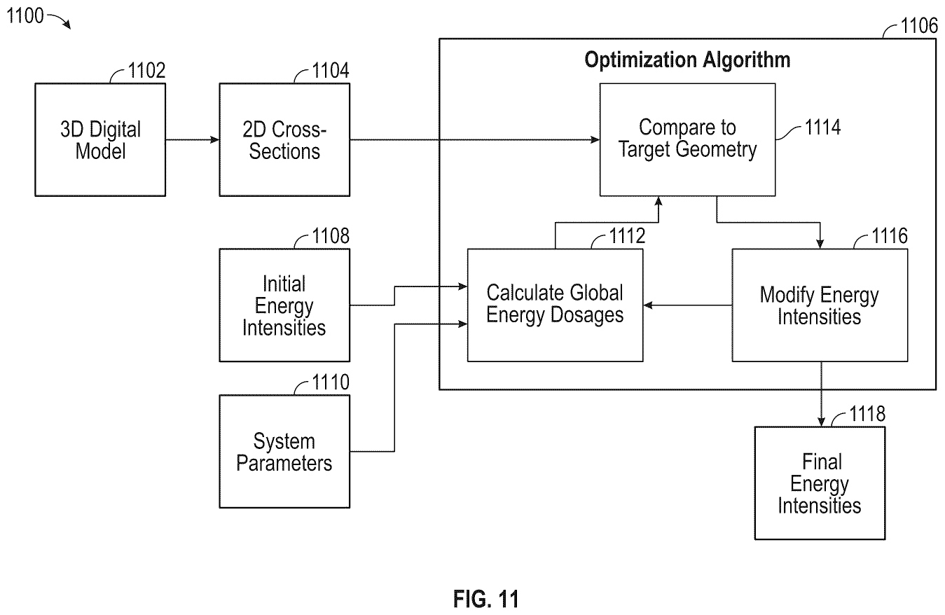

FIG. 11 is a schematic block diagram illustrating a workflow 1100 for determining energy intensities for fabricating an additively manufactured object, in accordance with embodiments of the present technology. The workflow 1100 can be used to determine energy intensities for the energy sources of any of the systems and devices described herein, such as any of the embodiments of FIGS. 1A-9C. The workflow 1100 can be performed in combination with any of the methods described herein, such as the method 1000 of FIG. 10A and/or the method 1030a of FIG. 10B. In some embodiments, some or all of the processes of the workflow 1100 are implemented as computer-readable instructions (e.g., program code) that are configured to be executed by one or more processors of a computing device.

The workflow 1100 can include receiving a 3D digital model of an object (block 1102) to be fabricated (e.g., a dental appliance). The 3D digital model can then be sliced into a plurality of 2D cross-sections (e.g., vertical (YZ) planes), which can be used as input into an optimization algorithm (block 1106) for determining energy intensities for fabricating the object using an additive manufacturing system with scanned energy sources, as described herein.

In some embodiments, the inputs to the optimization algorithm include a set of initial energy intensities for the energy sources (block 1108), such as laser intensities for a plurality of laser sources. Each energy source can have a plurality of initial energy intensity values for the corresponding energy beam over time and/or for each angle swept by the energy beam through the scanning region of the energy source. In some embodiments, for example, the scanning region of an energy source is discretized into at least 20, 50, 100, 200, 500, or 1000 different angles, and an initial energy intensity value is set for each angle. The initial energy intensity values can be randomized values, preset values, estimates of optimized values, values input by a user, etc.

The inputs to the optimization algorithm can optionally include one or more system parameters (block 1110). As described herein, the system parameters can represent fixed characteristics of the additive manufacturing system with the energy sources. For example, the system parameters can include physical printer parameters, such as locations of the energy sources (e.g., laser locations) and/or locations of reflective elements. Alternatively or in combination, the inputs to the optimization algorithm can include any of the other types of system parameters described herein.

The optimization algorithm can include calculating global energy dosages (block 1112) delivered to a curable material. The global energy dosages can be generated using a software prediction model that determines the energy dosages delivered to each voxel of the curable material, based on the initial energy intensities and the system parameters. The prediction model can use a ray tracing-based approach, analytical expressions, machine learning algorithms, rule-based algorithms, and/or any of the other techniques described herein. Optionally, the energy dosages can then be used to evaluate whether the curable material will be solidified or will remain unsolidified at each location, (e.g., by comparing the energy dosage to the threshold dosage), thereby predicting the object geometry that will be formed.

Subsequently, the optimization algorithm can compare the calculated global energy dosages to a target geometry for the object (block 1114). The target geometry can be the 2D cross-sections of the object. In some embodiments, the output of the global energy dosage calculations is a series of 2D digital representations (e.g., 2D images) representing the predicted energy dosage for each sweep of the energy sources through the curable material, and each 2D digital representation is compared to a corresponding 2D cross-section of the object. The comparison can involve evaluating the similarity between each 2D digital representation and the corresponding 2D cross-sections, such as by calculating an error between each 2D digital representation and the corresponding 2D cross-section.

Based on the comparison, the optimization algorithm can modify some or all of the energy intensities of the energy sources (block 1116). The modification can include, for example, increasing the energy intensity value at a particular time point/angle, decreasing the energy intensity value at a particular time point/angle, setting the energy intensity value to zero at a particular time point/angle, etc. The modifications can be configured to increase the similarity and/or decrease the error between the global energy dosages and the target geometry. In some embodiments, the modifications are determined using gradient descent and/or other optimization approaches known to those of skill in the art.

In some embodiments, the optimization algorithm involves repeating the processes of calculating energy dosages, comparing the dosages to the target geometry, and modifying the energy intensities until satisfactory values for the energy intensities are obtained (e.g., values that maximize the similarity and/or minimize the error between the global energy dosages and the target geometry). These values can then be used as the final energy intensities for generating fabrication instructions for the additive manufacturing system (block 1118).

Although the workflow 1100 is illustrated and described with respect to optimization of energy intensities, in other embodiments, the workflow 1100 can alternatively or additionally be used to optimize the values of any of the other types of scanning parameters described herein.

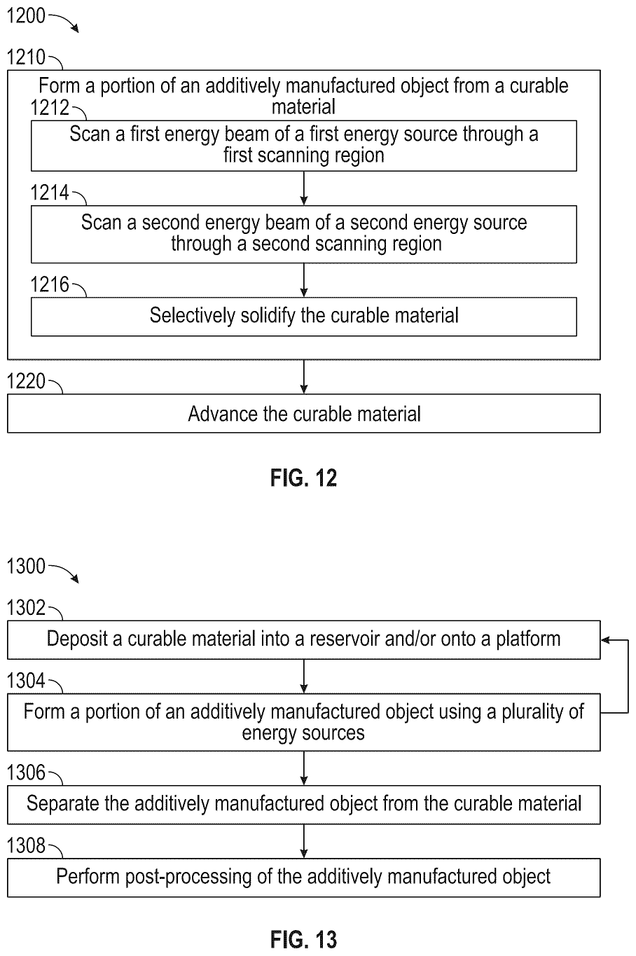

FIG. 12 is a flow diagram illustrating a method 1200 for fabricating an additively manufactured object, in accordance with embodiments of the present technology. The method 1200 can be performed by any of the systems and devices described herein, such as any of the embodiments of FIGS. 1A-9C. In some embodiments, some or all of the processes of the method 1200 are implemented as computer-readable instructions (e.g., program code) that are configured to be executed by one or more processors of a computing device, such as a controller. The method 1200 can be performed in combination with any of the other methods described herein, such as the embodiments of FIGS. 10A-11.

The method 1200 can begin at block 1210 with forming a portion of an additively manufactured object from a curable material. For instance, the additively manufactured object can be a dental appliance, such as an aligner, palatal expander, retainer, attachment placement device, mouth guard, etc. The curable material can be provided within a reservoir and/or on a movable platform, as described herein. The curable material can be a resin including one or more polymerizable components (e.g., monomers, oligomers, reactive polymers) that polymerize or otherwise undergo bond-forming reactions upon exposure to energy, as discussed above.

The process of block 1210 can include scanning a first energy beam of a first energy source through a first scanning region in the curable material (block 1212), and scanning a second energy beam of a second energy source through a second scanning region in the curable material (block 1214). For example, the first and second energy sources can be light sources (e.g., lasers, LEDs) that produce respective light beams. The scanning of the first and second energy beams can be performed using any suitable technique, such as a rotating optical element, a galvo motor scanning system or other energy directing system, and/or by moving the first and second energy sources relative to the curable material. The scanning of the first and second energy beams can be performed simultaneously or sequentially.

As described herein, the first and second scanning regions can each be a 2D region within the curable material that is produced by sweeping the respective energy beam through a plurality of different angles. The first and second scanning regions can be within the same plane or can be within different planes. In some embodiments, the first and second scanning regions are orthogonal to a movement direction of the reservoir (e.g., the X-direction), while in other embodiments, the first and/or second scanning region can be at another angle relative to the movement direction of the reservoir. The first and second scanning regions can overlap each other at one or more locations to define an overlap region. As described herein, the overlap region can be a set of voxels within the curable material that can be simultaneously or sequentially irradiated by both the first energy beam and the second energy beam.

The process of block 1210 can further include selectively solidifying the curable material (block 1216), thereby forming the portion of the additively manufactured object. In some embodiments, the curable material is selectively solidified by delivering a combined energy dosage to one or more object locations within the curable material with the first and second energy beams, such that the combined energy dosage is greater than or equal to a threshold dosage for solidifying the curable material (e.g., exceeds the gel point of the curable material). The one or more object locations can be within the overlap region of the first and second scanning regions, such that the first and second energy beams can be simultaneously or sequentially scanned through the object location(s) to deliver the combined energy dosage to the object location(s). To avoid solidifying the curable material at other locations within the overlap region, the scanning parameters (e.g., activation pattern, intensity, sweep rate) of the first and/or second energy beams can be controlled during scanning so that the combined energy dosage delivered to the other location(s) is less than the threshold dosage. The appropriate scanning parameters can be determined using a software algorithm, as described herein (e.g., in connection with FIGS. 10A-11).

At block 1220, the method 1200 can include advancing the curable material relative to the first and second energy sources. The curable material can be advanced, for instance, by moving the reservoir containing the curable material using a movable platform, as described herein. The movement direction can be orthogonal to the first and/or second scanning regions, or can be offset from (e.g., not parallel to) the first and/or second scanning regions. In some embodiments, the curable material is advanced simultaneously with the scanning of the first and/or second energy beams, while in other embodiments, the curable material is advanced sequentially (e.g., before or after) the scanning of the first and/or second energy beams.

The processes of blocks 1210-1220 can be repeated to form successive portions of the additively manufactured object, thereby building up the 3D object geometry from a plurality of 2D cross-sections.

The method 1200 illustrated in FIG. 12 can be modified in many different ways. For example, although the above processes of the method 1200 are described with respect to a single object, the method 1200 can be used to sequentially or concurrently fabricate any suitable number of objects, such as tens, hundreds, or thousands of additively manufactured objects. As another example, the ordering of the processes shown in FIG. 12 can be varied. Some of the processes of the method 1200 can be omitted and/or the method 1200 can include additional processes not shown in FIG. 12. For instance, the method 1200 can involve forming the portion of the additively object from one or more additional energy sources. In such embodiments, the process of block 1210 can involve scanning a third energy beam of a third energy source through a third scanning region, such that the combined energy dosage delivered to the object location(s) by two or more of the first, second, and/or third energy sources exceeds the threshold dosage; and so on.

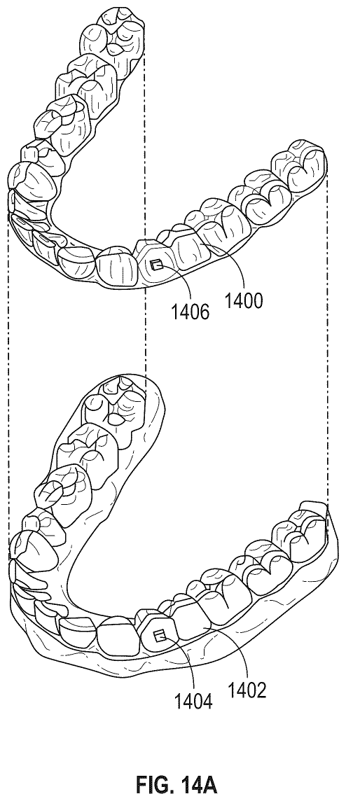

FIG. 13 is a flow diagram illustrating a method 1300 for fabricating and processing an additively manufactured object, in accordance with embodiments of the present technology. The method 1300 can be performed by any of the systems and devices described herein, such as any of the embodiments of FIGS. 1A-9C. In some embodiments, some or all of the processes of the method 1300 are implemented as computer-readable instructions (e.g., program code) that are configured to be executed by one or more processors of a computing device, such as a controller. Moreover, the method 1300 can be combined with any of the other methods described herein, such as the method 1200 of FIG. 12.

The method 1300 can begin at block 1302 with depositing a curable material (e.g., a polymerizable resin) into a reservoir and/or onto a platform. For example, the curable material can be deposited into a reservoir that is carried by a movable platform. Alternatively, the curable material can be deposited directly onto the movable platform (e.g., in embodiments where the curable material is a highly viscous resin that does not flow after deposition).

The curable material can be deposited into the reservoir as a substantially uniform layer. The layer can have any suitable thickness, such as a thickness within a range from 1 μm to 10 μm, 10 μm to 100 μm, 100 μm to 1 mm, 1 mm to 1 cm, or 1 cm to 10 cm, or can be greater than 10 cm. In some embodiments, the layer thickness is greater than or equal to the height of the additively manufactured object to be formed, while in other embodiments, the layer thickness is less than the height of the object. The layer thickness can be greater than the voxel size (e.g., Z dimension voxel size) of the object. For instance, the layer thickness can be at least 2×, 3×, 4×, 5×, 10×, 20×, 50×, 100× or 1000× the height of a single voxel (e.g., Z dimension of the voxel). In such embodiments, the voxel size stated can be the smallest voxel size in the Z dimension that the system and curable material can create under the printing conditions.

Deposition of the curable material can be performed using any suitable technique, such as using mechanical elements (e.g., doctor blades, wire-wrapped bars), spin coating, dip coating, spray coating (e.g., electrostatic spray coating), solvent casting, liquid casting with flow and leveling, jetting (e.g., inkjetting, compressed air jetting), extrusion (e.g., die extrusion, syringe extrusion, fused deposition modeling), pouring, dispensing a powder that is subsequently melted/fused, or suitable combinations thereof. In some embodiments, the curable material is introduced using a reactive dispensing technique, such as using static mixer attachments or inkjetting two materials that react when mixed. In some embodiments, the curable material is introduced using coextrusion or side-by-side extrusion. In embodiments where the curable material includes multiple components (e.g., multiple different resins), a first component (e.g., a first resin) can be introduced into the reservoir and/or onto the platform, then a nozzle or needle can be used to introduce a second component (e.g., a second resin) to one or more selected locations within and/or on the first component.

At block 1304, the method 1300 can continue with forming a portion of an additively manufactured object using a plurality of energy sources. The process of block 1304 can be performed according to the method 1200 of FIG. 12.

In some embodiments, the processes of blocks 1302 and 1304 are performed once to form the entire additively manufactured object. This approach can be used in embodiments where the layer thickness of the curable material is greater than or equal to the maximum height of the object. In other embodiments, however, the processes of blocks 1302 and 1304 can be repeated to build up the additively manufactured object from a series of layers. This approach can be used in embodiments where the layer thickness of the curable material is less than the maximum height of the object. For instance, a first layer of curable material can be deposited and used to form a first layer of the object, then a second layer of curable material can be deposited onto the first layer and used to form a second layer of the object, etc., until the entire object has been formed. Some or all of the object layers can be formed from the same curable material, or some or all of the object layers can be formed from different curable materials.

At block 1306, the method 1300 can include separating the additively manufactured object from the curable material. The process of block 1306 can involve removing the object from the curable material (e.g., by lifting the object out of the reservoir and/or off of the platform), removing the curable material from the object (e.g., by draining the curable material out of the reservoir and/or off of the platform), or a combination thereof.

In some embodiments, the remaining curable material is collected for reuse in a subsequent additive manufacturing process. Curable material that has been used in an additive manufacturing process may have been partially cured or even solidified in some regions. Thus, it may be advantageous to filter the curable material before reuse to remove any partially cured and/or solidified material, as well as any other debris and/or contaminants. Optionally, the curable material can be processed before reuse, such as by adding fresh curable material. One or more properties of the curable material can be monitored to ensure consistency of the curable material (and thus, consistency in object properties) using techniques such as UV-Vis absorption, viscosity, depth of cure measurements, photo differential scanning calorimetry, photo-rheology, Fourier transform infrared spectroscopy, etc.

At block 1308, the method 1300 can include performing one or more additional process steps, also referred to herein as “post-processing” of the additively manufactured object. In some embodiments, the post-processing involves removing residual material from the additively manufactured object. The residual material can include unincorporated curable material (e.g., liquid resin) and/or other unwanted material (e.g., debris) that remains on and/or within the object after the additive manufacturing process. The residual material can be removed in many different ways, such as by applying mechanical forces to the object (e.g., vibration, agitation, centrifugation, tumbling, brushing), exposing the object to a solvent (e.g., via spraying, immersion), heating or cooling the object, applying a vacuum to the object, blowing a pressurized gas onto the object, and/or other suitable techniques.

In some embodiments, the post-processing includes an additional curing step (“post-curing”). Post-curing can be used in situations where the object is still in a partially cured “green” state after fabrication. For example, the energy used to fabricate the object in block 1304 may only partially cure (e.g., polymerize) the curable material forming the object. Accordingly, the post-curing step may be needed to fully cure (e.g., fully polymerize) the object to its final, usable state. Post-curing can provide various benefits, such as improving the mechanical properties (e.g., stiffness, strength) and/or temperature stability of the object. Post-curing can be performed by heating the object, applying radiation (e.g., UV, visible, microwave) to the object, or suitable combinations thereof.

Optionally, the post-processing can include modifying at least one surface of the additively manufactured object. The surface modifications can be applied to some or all of the surfaces of the object (e.g., the exterior and/or interior surfaces) to alter one or more surface characteristics, such as the surface finish (e.g., roughness, waviness, lay), porosity, visual appearance (e.g., gloss, transparency, visibility of print lines), hydrophobicity, and/or chemical reactivity. In some embodiments, the surface modifications include removing material from the object, e.g., by polishing, milling, abrading, blasting, etc. Alternatively or in combination, the surface modifications can include applying an additional material to the object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., a dental appliance worn on the teeth); coloring and/or applying other aesthetic features to the object; improving scratch resistance and/or other mechanical properties; providing antimicrobial properties; and incorporating therapeutic agents into the object for controlled release. Examples of coating techniques that can be used include powdering coating, dip coating, and vapor coating.

Other examples of post-processing that may be performed include, but are not limited to, additional cleaning of the object (e.g., washing with water, solvents, etc.); annealing of the object; trimming or otherwise separating the object from any substrates, supports, and/or other structures that are not intended to be present in the final product; and packaging the object for shipment.

The method 1300 illustrated in FIG. 13 can be modified in many different ways. For example, although the above processes of the method 1300 are described with respect to a single object, the method 1300 can be used to sequentially or concurrently fabricate any suitable number of objects, such as tens, hundreds, or thousands of additively manufactured objects. As another example, the ordering of the processes shown in FIG. 13 can be varied. Some of the processes of the method 1300 can be omitted, such as any of the processes of blocks 1302, 1306, and/or 1308).

The method 1300 can also include additional processes not shown in FIG. 13. For example, the additively manufactured object can optionally be fabricated using a hybrid process involving at least one other additive manufacturing technique. Examples of other additive manufacturing techniques that can be used in combination with the present technology include any of the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing (VAM); (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. In such embodiments, a first portion of the object can be formed using the processes of blocks 1302 and 1304, and a second portion of the object can be formed using another additive manufacturing technique. The second portion can be formed before, concurrently with, or after forming the first portion of the object.

The various techniques described herein can be adapted to many different types of additive manufacturing modalities. For example, the process of selecting only portions of an object to optimize for resolution and ranking the degree of resolution desired for the different portions may be applied to other VAM methods such as xolography, computed axial lithography (CAL)-ed volumetric printing, etc. As another example, the selective overcuring of portions of an object to increase the green strength of an object is also applicable to many different additive manufacturing modalities. In a further example, the converging and diverging of energy beams to change the resolution of lower layer voxels can be used in SLA and vat-based systems. In yet another example, the use of extra mirrors and other reflective elements can be used in xolography and CAL volumetric printing. In another example, holographic or laser interference can also be used in other VAM methods.

### II. Dental Appliances and Associated Methods

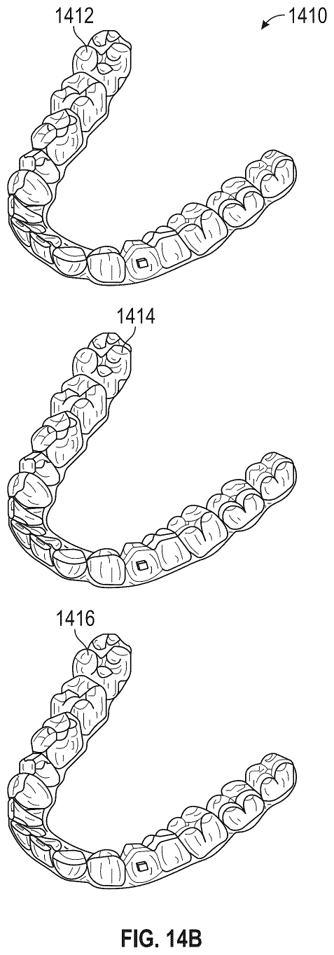

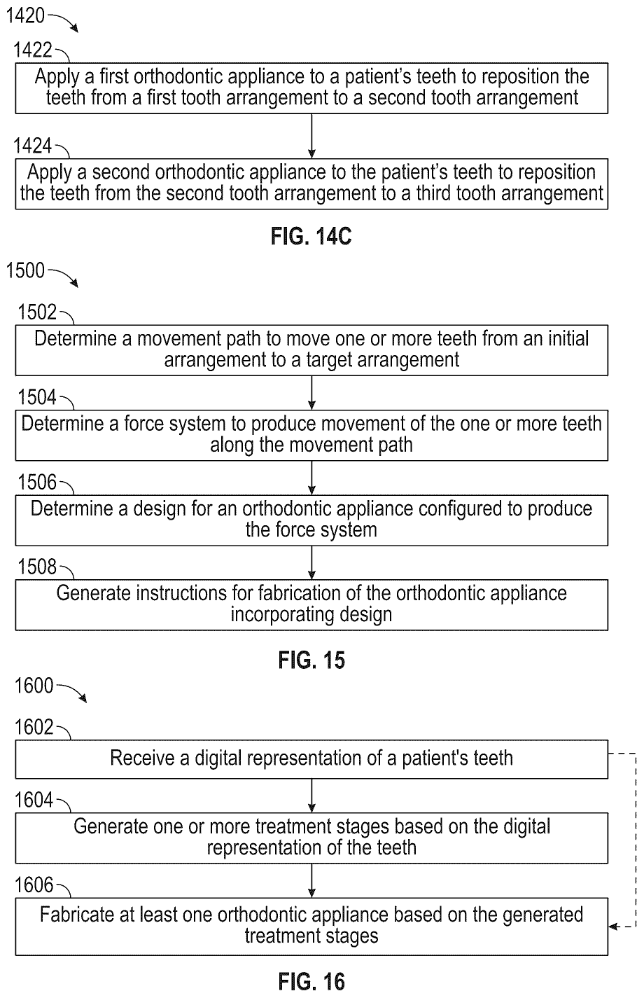

FIG. 14A illustrates a representative example of a tooth repositioning appliance 1400 configured in accordance with embodiments of the present technology. The appliance 1400 can be manufactured using any of the systems, methods, and devices described herein. The appliance 1400 (also referred to herein as an “aligner”) can be worn by a patient in order to achieve an incremental repositioning of individual teeth 1402 in the jaw. The appliance 1400 can include a shell (e.g., a continuous polymeric shell or a segmented shell) having teeth-receiving cavities that receive and resiliently reposition the teeth. The appliance 1400 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1400 can fit over all teeth present in an upper or lower jaw, or less than all of the teeth. The appliance 1400 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1400 can be a generic appliance configured to receive the teeth, but not necessarily shaped to match the topography of the patient's teeth. In some cases, only certain teeth received by the appliance 1400 are repositioned by the appliance 1400 while other teeth can provide a base or anchor region for holding the appliance 1400 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1400 in place over the teeth. In some cases, however, it may be desirable or necessary to provide individual attachments 1404 or other anchoring elements on teeth 1402 with corresponding receptacles 1406 or apertures in the appliance 1400 so that the appliance 1400 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 14B illustrates a tooth repositioning system 1410 including a plurality of appliances 1412, 1414, 1416, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1410 can include a first appliance 1412 corresponding to an initial tooth arrangement, one or more intermediate appliances 1414 corresponding to one or more intermediate arrangements, and a final appliance 1416 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, vencers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 14C illustrates a method 1420 of orthodontic treatment using a plurality of appliances, in accordance with embodiments of the present technology. The method 1420 can be practiced using any of the appliances or appliance sets described herein. In block 1422, a first orthodontic appliance is applied to a patient's teeth in order to reposition the teeth from a first tooth arrangement to a second tooth arrangement. In block 1424, a second orthodontic appliance is applied to the patient's teeth in order to reposition the teeth from the second tooth arrangement to a third tooth arrangement. The method 1420 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 15 illustrates a method 1500 for designing an orthodontic appliance, in accordance with embodiments of the present technology. The method 1500 can be applied to any embodiment of the orthodontic appliances described herein. Some or all of the steps of the method 1500 can be performed by any suitable data processing system or device, e.g., one or more processors configured with suitable instructions.

In block 1502, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1504, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1504 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1506, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including but not limited to finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1508, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1500 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1500 may be performed with any suitable fabrication system or device, such as the embodiments described herein. Some of the steps may be optional, e.g., the process of block 1504 can be omitted, such that the orthodontic appliance is designed based on the desired tooth movements and/or determined tooth movement path, rather than based on a force system. Moreover, the order of the steps can be varied as desired.

FIG. 16 illustrates a method 1600 for digitally planning an orthodontic treatment and/or design or fabrication of an appliance, in accordance with embodiments. The method 1600 can be applied to any of the treatment procedures described herein and can be performed by any suitable data processing system.

In block 1602 a digital representation of a patient's teeth is received. The digital representation can include surface topography and/or color data for the patient's intraoral cavity (including teeth, gingival tissues, etc.). The surface topography and/or color data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1604, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1606, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 16, design and/or fabrication of an orthodontic appliance, and perhaps a particular orthodontic treatment, may include use of a representation of the patient's teeth (e.g., including receiving a digital representation of the patient's teeth (block 1602)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The present technology is further illustrated by the following non-limiting examples.

### Example 1: Light Field Prediction Model Using Ray Tracing

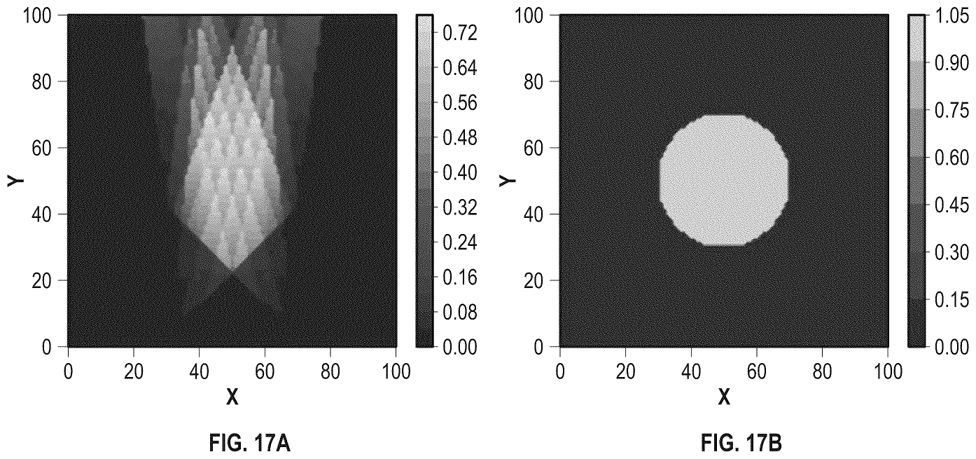

This example describes prediction of the global light dosage in a simulated material using a ray tracing-based approach. Predictions were made for different numbers and configurations of lasers sweeping through a single plane. Each laser was modeled as sweeping through a semicircle (from pointing horizontally left to pointing horizontally right) every second. The range of motion was discretized into 100 evenly spaced segments with independently tunable intensities. The predictions were used in an optimization procedure to determine the laser intensities over time to achieve a target shape. The legends in FIGS. 17A-21B show the normalized light dosage calculated using a sigmoid function that is adjusted to have its center near the middle of the light dosage range for the particular model setup.

FIG. 17A is a heatmap image illustrating a globally optimized light dosage using three collimated lasers and two reflective walls, and FIG. 17B is a heatmap image of the target shape for the optimization. Ray tracing was performed using three collimated lasers located at the top of the simulated material at (10, 130), (50, 130), and (90, 130). Vertical reflective walls were located at X=−20 and X=120. Optimization was performed globally over the entire plane.

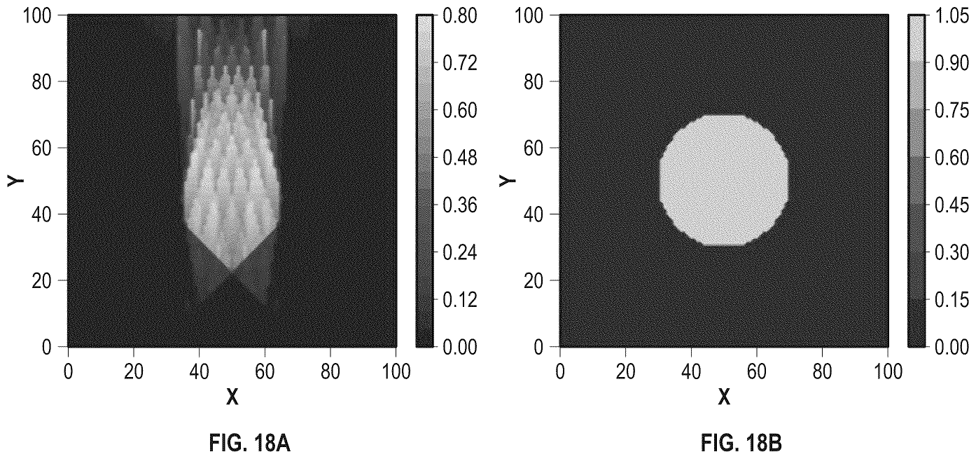

FIG. 18A is a heatmap image illustrating a globally optimized light dosage using five collimated lasers and two reflective walls, and FIG. 18B is a heatmap image of the target shape for the optimization. Ray tracing was performed using five collimated lasers located at the top of the simulated material at (10, 130), (30, 130), (50, 130), (70, 130) and (90, 130). Vertical reflective walls were located at X=−20 and X=120. Optimization was performed globally over the entire plane.

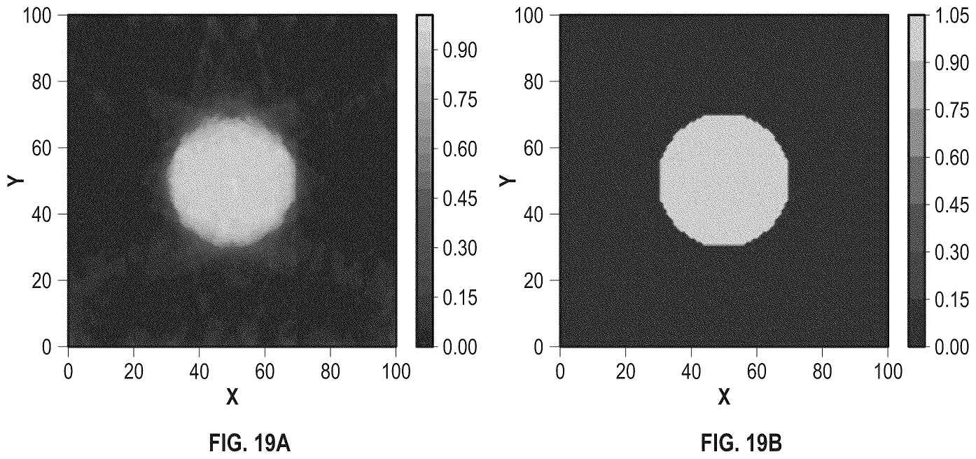

FIG. 19A is a heatmap image illustrating a globally optimized light dosage using ten collimated lasers and two reflective walls, and FIG. 19B is a heatmap image of the target shape for the optimization. Ray tracing was performed using five collimated lasers located at the top of the simulated material at (10, 130), (30, 130), (50, 130), (70, 130), and (90, 130), and five collimated lasers located at the bottom of the simulated material at (10, −30), (30, −30), (50, −30), (70, −30), and (90, −30). Vertical reflective walls were located at X=−20 and X=120. Optimization was performed globally over the entire plane.

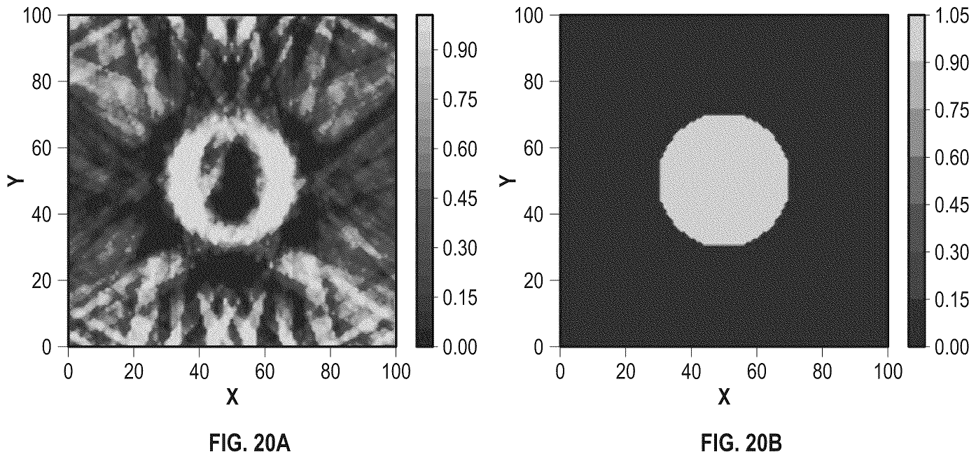

FIG. 20A is a heatmap image illustrating a locally optimized light dosage using ten collimated lasers and two reflective walls, and FIG. 20B is a heatmap image of the target shape for the optimization. Ray tracing was performed using five collimated lasers located at the top of the simulated material at (10, 130), (30, 130), (50, 130), (70, 130), and (90, 130), and five collimated lasers located at the bottom of the simulated material at (10, −30), (30, −30), (50, −30), (70, −30), and (90, −30). Vertical reflective walls were located at X=−20 and X=120. Optimization was performed locally for the boundary regions of the target shape (errors in the domain that were not near the edge of the target shape were ignored).

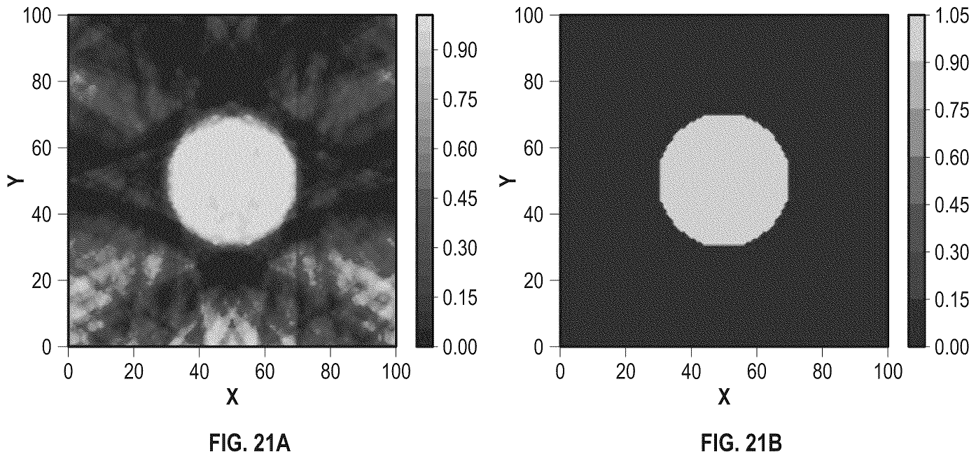

FIG. 21A is a heatmap image illustrating a locally optimized light dosage using ten converging lasers and two reflective walls, and FIG. 21B is a heatmap image of the target shape for the optimization. Ray tracing was performed using five converging lasers located at the top of the simulated material at (10, 130), (30, 130), (50, 130), (70, 130), and (90, 130), and five converging lasers located at the bottom of the simulated material at (10, −30), (30, −30), (50, −30), (70, −30), and (90, −30). Vertical reflective walls were located at X=−20 and X=120. Optimization was performed locally for the boundary regions of the target shape (errors in the domain that were not near the edge of the target shape were ignored).

Overall, these results demonstrate that the number of lasers and laser location can significantly impact accuracy of the object geometry. Laser collimation is another parameter that can affect the geometry. Performing optimization on only the voxels near the boundaries can achieve better accuracy near the regions of interest, while relaxing constraints at other locations in the computational domain.

### Example 2: Comparison of Layer-by-Layer and Volumetric Scanning Processes

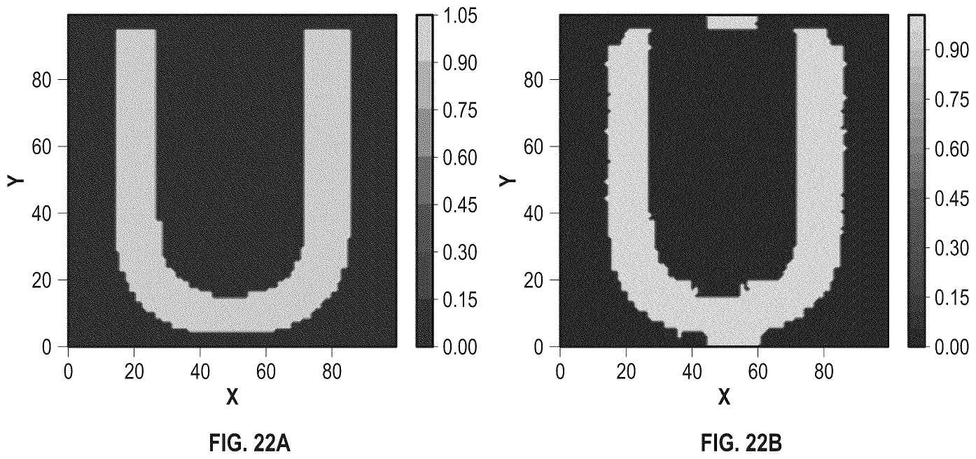

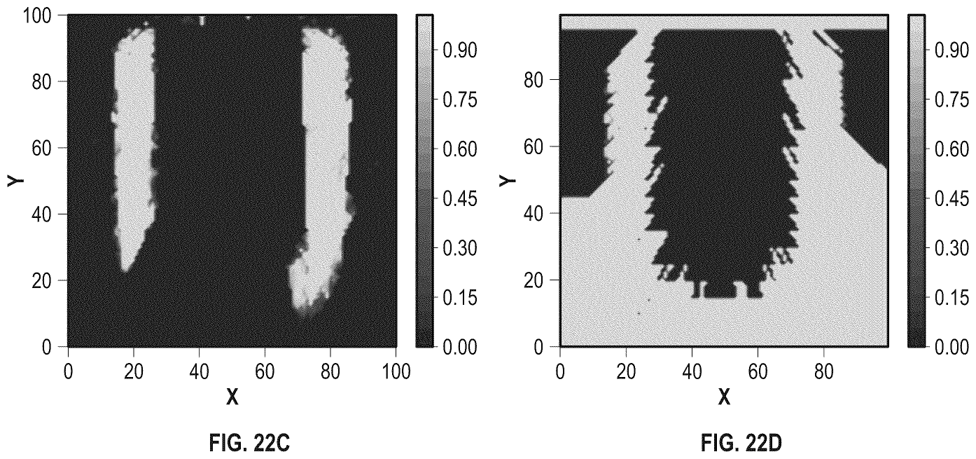

This example describes comparison of the global light dosage achieved via layer-by-layer scanning versus volumetric scanning. Predictions of global light dosages were made in a simulated material using a ray tracing-based approach in accordance with the methods of Example 1 above. The legends in FIGS. 22A-22D show the normalized light dosage calculated using a sigmoid function that is adjusted to have its center near the middle of the light dosage range for the particular model setup.

FIG. 22A is a heatmap image illustrating a target object shape, FIG. 22B is a heatmap illustrating a predicted global light dosage using five lasers and layer-by-layer scanning, FIG. 22C is a heatmap illustrating a predicted global light dosage using five lasers and volumetric scanning, and FIG. 22D is a heatmap illustrating a predicted global light dosage using one laser and layer-by-layer scanning. For layer-by-layer scanning (FIGS. 22B and 22D), the computational domain was divided into 20 horizontal layers with a layer height of 5 mm, and the light dosage was computed for sequential scanning of the layers. For volumetric scanning, the light dosage was computed for the scanning of the entire X-Y plane at once. For the five laser configuration (FIGS. 22B and 22C), lasers were located above the simulated material at (10, 130), (30, 130), (50, 130), (70, 130), and (90, 130). For the single laser configuration (FIG. 22D), the laser was located above the simulated material at (50, 130).

These results demonstrate that layer-by-layer scanning (FIG. 22B) can produce improved resolution and fidelity to the target object shape compared to volumetric scanning (FIG. 22C). Resolution and fidelity for the layer-by-layer scanning process can also be improved by including multiple lasers (FIG. 22B) rather than a single laser (FIG. 22D).

### ADDITIONAL EXAMPLES

The following examples are included to further describe some aspects of the present technology, and should not be used to limit the scope of the technology.

Clause 1. A method comprising:
(a) forming a portion of an additively manufactured object within a reservoir of curable material by:
   scanning a first energy beam of a first energy source through a first scanning region within the reservoir of the curable material,
   scanning a second energy beam of a second energy source through a second scanning region within the reservoir of the curable material, wherein the second scanning region overlaps the first scanning region at one or more object locations, and
   delivering a combined energy dosage to the one or more object locations with the first and second energy beams that is greater than or equal to a threshold dosage for solidifying the curable material,
(b) advancing the reservoir of curable material relative to the first and second energy sources; and
(c) repeating the processes of (a) and (b) to fabricate the additively manufactured object.

Clause 2. The method of Clause 1, wherein the first and second energy beams are simultaneously scanned through at least one of the one or more object locations.

Clause 3. The method of Clause 1 or 2, wherein the first and second energy beams are sequentially scanned through at least one of the one or more object locations.

Clause 4. The method of any one of Clauses 1 to 3, further comprising:
controlling an activation pattern of the first energy source while scanning the first energy beam through the first scanning region, and
controlling an activation pattern of the second energy source while scanning the second energy beam through the second scanning region.

Clause 5. The method of Clause 4, wherein the activation patterns of the first and second energy sources are configured to cause the curable material to be selectively solidified at the one or more object locations.

Clause 6. The method of any one of Clauses 1 to 5, further comprising:
controlling an energy intensity of the first energy source while scanning the first energy beam through the first scanning region, and
controlling an energy intensity of the second energy source while scanning the second energy beam through the second scanning region.

Clause 7. The method of Clause 6, wherein the energy intensities of the first and second energy sources are configured to cause the curable material to be selectively solidified at the one or more object locations.

Clause 8. The method of any one of Clauses 1 to 7, wherein the curable material is not solidified at one or more other locations different from the one or more object locations.

Clause 9. The method of Clause 8, wherein the one or more other locations are located in the first scanning region only or in the second scanning region only.

Clause 10. The method of Clause 8, wherein the second scanning region overlaps the first scanning region at the one or more other locations, and wherein a combined energy dosage delivered to the one or more other locations with the first and second energy beams is less than the threshold dosage for solidifying the curable material.

Clause 11. The method of any one of Clauses 1 to 10, wherein:
scanning the first energy beam of the first energy source comprises directing the first energy beam onto a first rotating optical element, and
scanning the second energy beam of the second energy source comprises directing the second energy beam onto a second rotating optical element.

Clause 12. The method of any one of Clauses 1 to 11, wherein the first and second scanning regions lie within the same plane.

Clause 13. The method of any one of Clauses 1 to 11, wherein the first and second scanning regions lie within different planes.

Clause 14. The method of any one of Clauses 1 to 13, wherein one or more of the first or second scanning regions lie within a plane orthogonal to a movement direction of the reservoir.

Clause 15. The method of any one of Clauses 1 to 14, wherein the first and second energy sources are arranged in an array orthogonal to a movement direction of the reservoir.

Clause 16. The method of any one of Clauses 1 to 15, wherein the process of (a) further comprises:
scanning a third energy beam of a third energy source through a third scanning region within the reservoir of the curable material, wherein the third scanning region overlaps the first and second scanning regions at the one or more object locations, and
delivering a combined energy dosage to the one or more object locations with the first, second, and third energy beams that is greater than or equal to the threshold dosage for solidifying the curable material.

Clause 17. The method of any one of Clauses 1 to 16, wherein the reservoir comprises an upper opening, and the first and second energy beams are directed through the upper opening of the reservoir to reach the curable material.

Clause 18. The method of any one of Clauses 1 to 17, wherein the curable material comprises a resin including one or more polymerizable components.

Clause 19. The method of any one of Clauses 1 to 18, wherein the additively manufactured object comprises a dental appliance.

Clause 20. A system for fabricating an additively manufactured object, the system comprising:
a first energy source configured to output a first energy beam;
a second energy source configured to output a second energy beam;
a reservoir of a curable material;
a processor; and
a memory operably coupled to the processor and storing instructions that, when executed by the processor, cause the system to perform operations comprising:
   (a) forming a portion of the additively manufactured object by:
      scanning the first energy beam through a first scanning region within the reservoir of the curable material,
      scanning the second energy beam through a second scanning region within the reservoir of the curable material, wherein the second scanning region overlaps the first scanning region at one or more object locations, and
      delivering a combined energy dosage to the one or more object locations with the first and second energy beams that is greater than or equal to a threshold dosage for solidifying the curable material,
   (b) advancing the reservoir of curable material relative to the first and second energy sources; and
   (c) repeating the processes of (a) and (b) to fabricate the additively manufactured object.

Clause 21. The system of Clause 20, wherein the first and second energy beams are simultaneously scanned through at least one of the one or more object locations.

Clause 22. The system of Clause 20 or 21, wherein the first and second energy beams are sequentially scanned through at least one of the one or more object locations.

Clause 23. The system of any one of Clauses 20 to 22, wherein the operations further comprise:
controlling an activation pattern of the first energy source while scanning the first energy beam through the first scanning region, and
controlling an activation pattern of the second energy source while scanning the second energy beam through the second scanning region.

Clause 24. The system of Clause 23, wherein the activation patterns of the first and second energy sources are configured to cause the curable material to be selectively solidified at the one or more object locations.

Clause 25. The system of any one of Clauses 20 to 24, wherein the operations further comprise:
controlling an energy intensity of the first energy source while scanning the first energy beam through the first scanning region, and
controlling an energy intensity of the second energy source while scanning the second energy beam through the second scanning region.

Clause 26. The system of Clause 25, wherein the energy intensities of the first and second energy sources are configured to cause the curable material to be selectively solidified at the one or more object locations.

Clause 27. The system of any one of Clauses 20 to 26, wherein the curable material is not solidified at one or more other locations different from the one or more object locations.

Clause 28. The system of Clause 27, wherein the one or more other locations are located in the first scanning region only or in the second scanning region only.

Clause 29. The system of Clause 27, wherein the second scanning region overlaps the first scanning region at the one or more other locations, and wherein a combined energy dosage delivered to the one or more other locations with the first and second energy beams is less than the threshold dosage for solidifying the curable material.

Clause 30. The system of any one of Clauses 20 to 29, wherein:
the first energy source comprises a first rotating optical element configured to control a direction of the first energy beam, and
the second energy source comprises a second rotating optical element configured to control a direction of the second energy beam.

Clause 31. The system of any one of Clauses 20 to 30, wherein the first and second scanning regions lie within the same plane.

Clause 32. The system of any one of Clauses 20 to 30, wherein the first and second scanning regions lie within different planes.

Clause 33. The system of any one of Clauses 20 to 32, wherein one or more of the first or second scanning regions lie within a plane orthogonal to a movement direction of the reservoir.

Clause 34. The system of any one of Clauses 20 to 33, wherein the first and second energy sources are arranged in an array orthogonal to a movement direction of the reservoir.

Clause 35. The system of any one of Clauses 20 to 34, further comprising a third energy source configured to output a third energy beam.

Clause 36. The system of Clause 35, wherein the process of (a) further comprises:
scanning the third energy beam through a third scanning region within the reservoir of the curable material, wherein the third scanning region overlaps the first and second scanning regions at the one or more object locations, and
delivering a combined energy dosage to the one or more object locations with the first, second, and third energy beams that is greater than or equal to the threshold dosage for solidifying the curable material.

Clause 37. The system of any one of Clauses 20 to 36, wherein the reservoir comprises an upper opening, and the first and second energy beams are directed through the upper opening of the reservoir to reach the curable material.

Clause 38. The system of any one of Clauses 20 to 37, wherein the curable material comprises a resin including one or more polymerizable components.

Clause 39. The system of any one of Clauses 20 to 38, wherein the additively manufactured object comprises a dental appliance.

Clause 40. A non-transitory computer-readable storage medium comprising instructions that, when executed by one or more processors of an additive manufacturing system, cause the additive manufacturing system to perform operations comprising:
(a) forming a portion of an additively manufactured object within a reservoir of curable material by:
   scanning a first energy beam of a first energy source through a first scanning region within the reservoir of the curable material,
   scanning a second energy beam of a second energy source through a second scanning region within the reservoir of the curable material, wherein the second scanning region overlaps the first scanning region at one or more object locations, and
   delivering a combined energy dosage to the one or more object locations with the first and second energy beams that is greater than or equal a threshold dosage for solidifying the curable material,
(b) advancing the reservoir of curable material relative to the first and second energy sources; and
(c) repeating the processes of (a) and (b) to fabricate the additively manufactured object.

Clause 41. A method comprising:
receiving a 3D digital representation of an object to be fabricated;
generating a plurality of 2D cross-sections from the 3D digital representation;
determining scanning parameters for a plurality of energy sources to form the plurality of 2D cross-sections from a curable material, wherein the plurality of energy sources are configured to be scanned through a plurality of respective scanning regions within the curable material, and wherein the plurality of respective scanning regions overlap at one or more object locations; and
generating instructions for fabricating the object from the curable material using the plurality of energy sources with the scanning parameters.

Clause 42. The method of Clause 41, wherein the scanning parameters are configured to cause the plurality of energy sources to deliver a combined energy dosage to the one or more object locations that is greater than or equal to a threshold dosage for solidifying the curable material.

Clause 43. The method of Clause 41 or 42, wherein the scanning parameters are configured to cause the plurality of energy sources to selectively solidify the curable material at the one or more object locations and to not solidify the curable material at one or more other locations different from the one or more object locations.

Clause 44. The method of any one of Clauses 41 to 43, wherein the scanning parameters comprise one or more of the following, for each energy source of the plurality of energy sources: whether the energy source is on or off, an energy intensity of the energy source, or a sweep rate of the energy source.

Clause 45. The method of any one of Clauses 41 to 44, wherein each energy source is configured to output a respective energy beam that is scanned through the respective scanning region.

Clause 46. The method of any one of Clauses 41 to 45, wherein determining the scanning parameters comprises:
generating a prediction of an object geometry formed using the plurality of energy sources with the scanning parameters, and
comparing the prediction of the object geometry to at least one 2D cross-section of the plurality of 2D cross-sections.

Clause 47. The method of Clause 46, wherein the prediction is generated using ray tracing.

Clause 48. The method of Clause 46, wherein the prediction is generated using an analytical expression.

Clause 49. The method of any one of Clauses 46 to 48, wherein the prediction is generated based on one or more system parameters of an additive manufacturing system including the plurality of energy sources.

Clause 50. The method of Clause 49, wherein the one or more system parameters comprise locations of the plurality of energy sources.

Clause 51. The method of Clause 49 or 50, wherein the one or more system parameters comprise locations of one or more reflective elements that are configured to deflect an energy beam produced by at least one energy source of the plurality of energy sources.

Clause 52. The method of any one of Clauses 46 to 51, wherein the comparison comprises calculating an error between the prediction of the object geometry and the at least one 2D cross-section.

Clause 53. The method of any one of Clauses 46 to 52, wherein determining the scanning parameters further comprises:
modifying the scanning parameters based on the comparison, and
generating a second prediction of the object geometry formed using the plurality of energy sources with the modified scanning parameters.

Clause 54. The method of any one of Clauses 46 to 53, wherein the object comprises a dental appliance.

Clause 55. A system comprising:
a processor; and
a memory operably coupled to the processor and storing instructions that, when executed by the processor, cause the system to perform operations comprising:
   receiving a 3D digital representation of an object to be fabricated,
   generating a plurality of 2D cross-sections from the 3D digital representation,
   determining scanning parameters for a plurality of energy sources to form the plurality of 2D cross-sections from a curable material, wherein the plurality of energy sources are configured to be scanned through a plurality of respective scanning regions within the curable material, and wherein the plurality of respective scanning regions overlap at one or more object locations, and
   generating instructions for fabricating the object from the curable material using the plurality of energy sources with the scanning parameters.

Clause 56. The system of Clause 55, wherein the scanning parameters are configured to cause the plurality of energy sources to deliver a combined energy dosage to the one or more object locations that is greater than or equal to a threshold dosage for solidifying the curable material.

Clause 57. The system of Clause 55 or 56, wherein the scanning parameters are configured to cause the plurality of energy sources to selectively solidify the curable material at the one or more object locations and to not solidify the curable material at one or more other locations different from the one or more object locations.

Clause 58. The system of any one of Clauses 55 to 57, wherein the scanning parameters comprise one or more of the following, for each energy source of the plurality of energy sources: whether the energy source is on or off, an energy intensity of the energy source, or a sweep rate of the energy source.

Clause 59. The system of any one of Clauses 55 to 58, wherein each energy source is configured to output a respective energy beam that is scanned through the respective scanning region.

Clause 60. The system of any one of Clauses 55 to 59, wherein determining the scanning parameters comprises:
generating a prediction of an object geometry formed using the plurality of energy sources with the scanning parameters, and comparing the prediction of the object geometry to at least one 2D cross-section of the plurality of 2D cross-sections.

Clause 61. The system of Clause 60, wherein the prediction is generated using ray tracing.

Clause 62. The system of Clause 60, wherein the prediction is generated using an analytical expression.

Clause 63. The system of any one of Clauses 60 to 62, wherein the prediction is generated based on one or more system parameters of an additive manufacturing system including the plurality of energy sources.

Clause 64. The system of Clause 63, wherein the one or more system parameters comprise locations of the plurality of energy sources.

Clause 65. The system of Clause 63 or 64, wherein the one or more system parameters comprise locations of one or more reflective elements that are configured to deflect an energy beam produced by at least one energy source of the plurality of energy sources.

Clause 66. The system of any one of Clauses 60 to 65, wherein the comparison comprises calculating an error between the prediction of the object geometry and the at least one 2D cross-section.

Clause 67. The system of any one of Clauses 60 to 66, wherein determining the scanning parameters comprises further comprises:
modifying the scanning parameters based on the comparison, and
generating a second prediction of the object geometry formed using the plurality of energy sources with the modified scanning parameters.

Clause 68. The system of any one of Clauses 55 to 67, wherein the object comprises a dental appliance.

Clause 69. A non-transitory computer-readable storage medium comprising instructions that, when executed by one or more processors of a computing system, cause the computing system to perform operations comprising:
receiving a 3D digital representation of an object to be fabricated;
generating a plurality of 2D cross-sections from the 3D digital representation;
determining scanning parameters for a plurality of energy sources to form the plurality of 2D cross-sections from a curable material, wherein the plurality of energy sources are configured to be scanned through a plurality of respective scanning regions within the curable material, and wherein the plurality of respective scanning regions overlap at one or more object locations; and
generating instructions for fabricating the object from the curable material using the plurality of energy sources with the scanning parameters.

### CONCLUSION

Although many of the embodiments are described above with respect to systems, devices, and methods for manufacturing dental appliances, the technology is applicable to other applications and/or other approaches, such as manufacturing of other types of objects such as prototypes, hybrid composite materials, integrated electronics, medical devices, or aerospace materials or devices. Additionally, many of the methods, techniques, and processes described here are directly applicable to other forms of volumetric additive manufacturing. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-22D.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
(a) forming a portion of an additively manufactured object within a reservoir of curable material by:
scanning a first energy beam of a first energy source through a first scanning region within the reservoir of the curable material,
scanning a second energy beam of a second energy source through a second scanning region within the reservoir of the curable material, wherein the second scanning region overlaps the first scanning region at one or more object locations, and
delivering a combined energy dosage to the one or more object locations with the first and second energy beams that is greater than or equal to a threshold dosage for solidifying the curable material,
(b) advancing the reservoir of curable material relative to the first and second energy sources; and
(c) repeating the processes of (a) and (b) to fabricate the additively manufactured object.

2. The method of claim 1, wherein the first and second energy beams are simultaneously scanned through at least one of the one or more object locations.

3. The method of claim 1, wherein the first and second energy beams are sequentially scanned through at least one of the one or more object locations.

4. The method of claim 1, further comprising:
controlling an activation pattern of the first energy source while scanning the first energy beam through the first scanning region, and
controlling an activation pattern of the second energy source while scanning the second energy beam through the second scanning region.

5. The method of claim 4, wherein the activation patterns of the first and second energy sources are configured to cause the curable material to be selectively solidified at the one or more object locations.

6. The method of claim 1, further comprising:
controlling an energy intensity of the first energy source while scanning the first energy beam through the first scanning region, and
controlling an energy intensity of the second energy source while scanning the second energy beam through the second scanning region.

7. The method of claim 6, wherein the energy intensities of the first and second energy sources are configured to cause the curable material to be selectively solidified at the one or more object locations.

8. The method of claim 1, wherein the curable material is not solidified at one or more other locations different from the one or more object locations.

9. The method of claim 8, wherein the one or more other locations are located in the first scanning region only or in the second scanning region only.

10. The method of claim 8, wherein the second scanning region overlaps the first scanning region at the one or more other locations, and wherein a combined energy dosage delivered to the one or more other locations with the first and second energy beams is less than the threshold dosage for solidifying the curable material.

11. The method of claim 1, wherein:
scanning the first energy beam of the first energy source comprises directing the first energy beam onto a first rotating optical element, and
scanning the second energy beam of the second energy source comprises directing the second energy beam onto a second rotating optical element.

12. The method of claim 1, wherein the first and second scanning regions lie within the same plane.

13. The method of claim 1, wherein the first and second scanning regions lie within different planes.

14. The method of claim 1, wherein one or more of the first or second scanning regions lie within a plane orthogonal to a movement direction of the reservoir.

15. The method of claim 1, wherein the first and second energy sources are arranged in an array orthogonal to a movement direction of the reservoir.

16. The method of claim 1, wherein the process of (a) further comprises:
scanning a third energy beam of a third energy source through a third scanning region within the reservoir of the curable material, wherein the third scanning region overlaps the first and second scanning regions at the one or more object locations, and
delivering a combined energy dosage to the one or more object locations with the first, second, and third energy beams that is greater than or equal to the threshold dosage for solidifying the curable material.

17. The method of claim 1, wherein the reservoir comprises an upper opening, and the first and second energy beams are directed through the upper opening of the reservoir to reach the curable material.

18. The method of claim 1, wherein the reservoir comprises or is coupled to one or more reflective elements that are configured to deflect at least one of the first or second energy beams.

19. The method of claim 1, wherein the curable material comprises a resin including one or more polymerizable components.

20. The method of claim 1, wherein the additively manufactured object comprises a dental appliance.
